(19) United States
(12) Patent Application Publication
(10) Pub. No.: US 2026/0141361 A1
(43) Pub. Date: May 21, 2026

(54) BLOCKCHAIN BASED TRANSFER OF OFFCHAIN ASSETS

(71) Applicant: Unstoppable Domains, Inc., Las Vegas, NV (US)

(72) Inventors: Matthew Gould, Atlanta, GA (US); Lisa Seacat DeLuca, Bozeman, MT (US)

(21) Appl. No.: 19/022,145

(22) Filed: Jan. 15, 2025

Related U.S. Application Data
(60) Provisional application No. 63/722,234, filed on Nov. 19, 2024.

(51) Int. Cl. G06Q 20/06; G06Q 20/36

(52) U.S. Cl. CPC G06Q 20/065; G06Q 20/36; G06Q 2220/00

(57) ABSTRACT

According to a present invention embodiment, a system acquires an onchain asset of a blockchain for a user. The onchain asset corresponds to an offchain asset of the user and indicates ownership of the offchain asset. The onchain asset is transferred to one or more recipients on the blockchain. Transferring the onchain asset changes an ownership indication on the blockchain for the offchain asset to a corresponding recipient. Transfer of the offchain asset is deferred until requested by a recipient possessing the onchain asset. The offchain asset is transferred to the recipient in response to a request from the recipient to transfer the offchain asset. Embodiments of the present invention further include a method and computer program product for transferring assets of a computer environment in substantially the same manner described above.

### CROSS-REFRENCE TO RELATED APPLICATIONS

This application claims priority to U.S. Provisional Patent Application Ser. No. 63/722,234, entitled “Blockchain Based Transfer of Offchain Assets” and filed on Nov. 19, 2024, the disclosure of which is incorporated herein by reference in its entirety.

### TECHNICAL FIELD

Present invention embodiments relate to networking and, more specifically, to transfer of offchain assets (e.g., Web2 domains or domain names, ICANN domains or domain names, Domain Name System (DNS) domains or domain names, assets of other centralized domain systems, etc.) based on blockchain technology.

### BACKGROUND

### Discussion of the Related Art

Web2 generally refers to a version of the web (or Internet) that utilizes a centralized Domain Name System (DNS) to translate domain names into corresponding Internet Protocol (IP) addresses in order to access a web site. In contrast, Web3 generally refers to a decentralized version of the web (or Internet) based on blockchains and peer-to-peer networks.

Marketplaces and brokerage services for Web2 domain names facilitate the transferring of domain names in the Domain Name System (DNS) ecosystem. These platforms help connect domain name owners with potential users interested in acquiring the domain names and manage the often complex and lengthy transfer process.

Once a transaction for acquisition of a Web2 domain is conducted, the domain transfer process is initiated. This process transfers the Web2 domain from the owner registrar account to an acquiring user registrar account. However, the transfer process is not instantaneous and can involve several operations and delays. Additionally, there may be transfer restrictions. For example, some domain extensions may have specific rules or restrictions regarding transfers. By way of example, country-code top-level domains (ccTLDs) may have unique transfer requirements based on the country of registration.

Domain marketplaces and brokerage services for Web2 domains are members of the domain name economy and provide users with an efficient way to transfer domain names. While the process of transferring domains can be relatively straightforward, the existence of domain locks, the need for authorization codes, and the transfer waiting periods (e.g., a sixty day rule, etc.) are factors that can delay the final ownership change.

### SUMMARY

According to one embodiment of the present invention, a system for transferring assets of a computer environment comprises one or more memories and at least one processor coupled to the one or more memories. The system acquires an onchain asset of a blockchain for a user. The onchain asset corresponds to an offchain asset of the user and indicates ownership of the offchain asset. The onchain asset is transferred to one or more recipients on the blockchain. Transferring the onchain asset changes an ownership indication on the blockchain for the offchain asset to a corresponding recipient. Transfer of the offchain asset is deferred until requested by a recipient possessing the onchain asset. The offchain asset is transferred to the recipient in response to a request from the recipient to transfer the offchain asset. Embodiments of the present invention further include a method and computer program product (e.g., including one or more computer readable media with instructions executable by one or more processors) for transferring assets of a computer environment in substantially the same manner described above.

### BRIEF DESCRIPTION OF THE DRAWINGS

Generally, like reference numerals in the various figures are utilized to designate like components.

FIG. 1 is a diagrammatic illustration of an example computing environment according to an embodiment of the present invention.

FIG. 2 is a block diagram of an example computing device according to an embodiment of the present invention.

FIG. 3 is a flowchart of a method of registering a name or other identifier for an onchain asset (e.g., Web3, blockchain, etc.) based on a name or other identifier for an offchain asset (e.g., Web2, Domain Name System (DNS), etc.) according to an embodiment of the present invention.

FIG. 4 is a procedural flowchart of a method of transferring an offchain asset between users via a blockchain according to an embodiment of the present invention.

FIG. 5 is a flow diagram of a method of transferring an offchain asset between users via a blockchain according to an embodiment of the present invention.

FIG. 6 is a procedural flowchart of a method of transferring an offchain asset between user wallet accounts for transfer to another user according to an embodiment of the present invention.

FIG. 7 is a flow diagram of a method of transferring an offchain asset between user wallet accounts for transfer to another user according to an embodiment of the present invention.

### DETAILED DESCRIPTION

Web2 generally refers to a version of the web (or Internet) that utilizes a centralized Domain Name System (DNS) to translate domain names into corresponding Internet Protocol (IP) addresses in order to access a web site. Domain Name System (DNS) creates a set of one or more records when a domain name is registered. DNS records (or text files) reside in DNS servers and provide information pertaining to a domain name including an associated IP address and request handling.

In contrast, Web3 generally refers to a decentralized version of the web (or Internet) based on blockchains and peer-to-peer networks.

Marketplaces and brokerage services for Web2 domain names facilitate the transfer of domain names in the Domain Name System (DNS) ecosystem. These platforms help connect owners of domain names with potential users interested in acquiring the domain names and manage the often complex and lengthy transfer process.

Marketplaces for Web2 domain names are online platforms where domain owners list their available domains, and prospective users interested in acquiring domains can search, negotiate, and acquire the domains. These marketplaces provide a transparent and centralized manner for connecting owners with prospective acquirers, and often offer tools that streamline the entire transaction process, including valuation guidance, escrow services, and actual transfer of the domain name.

Owners can list their Web2 domain names on these platforms and set a value or select an auction-style listing. Owners may also negotiate directly with interested users when the listing is auction-based. Interested users can browse available domains via keyword searches, category filters, or domain extensions (.com, .org, .ai, etc.). Marketplaces often provide domain valuation tools to help interested users understand the market value of a domain name.

Some marketplaces allow interested users to acquire domains immediately at a fixed value (typically in the case of premium domains). In other cases, marketplaces enable owners and interested users to negotiate the value, often involving an option for the interested user to provide an offer. The platforms may offer built-in valuation tools to help establish fair market values based on comparable domain transfers.

Once an agreement is reached between an owner and interested user, most domain marketplaces use escrow services to secure payment while the transfer of the domain name is processed. The interested user deposits the payment into escrow, and the owner proceeds with transferring the domain. This service ensures availability of the payment of the interested user before receiving the domain, while the owner is protected from any potential payment issues.

For those who may not have the time or expertise to navigate the domain transfer process, domain brokers provide professional assistance. These brokers act as intermediaries between owners and interested users, and facilitate the negotiation and transfer of Web2 domain names. The domain brokers help secure the best value for the domain, leveraging their networks and market knowledge. In addition, domain brokers often handle high-value transactions that may not be listed publicly on marketplaces. These transactions typically involve high-net-worth users, large corporations, or investors.

Once a transaction for a Web2 domain is conducted, the domain transfer process is initiated. This process transfers the Web2 domain from the owner registrar account to the registrar account of the interested user acquiring the domain. However, the transfer process is not instantaneous and can involve several operations and delays.

In order to commence the transfer, the owner ensures that the domain is unlocked at their registrar. This is typically accomplished by logging into the registrar control panel and disabling any locks that prevent unauthorized transfers. Registrar locks are in place to prevent domain theft or accidental transfers, and unlocking a domain requires action from the owner. This unlocking operation occurs before initiating the transfer to the interested user.

Once the domain is unlocked, the owner provides an authorization code (e.g. an Extensible Provisioning Protocol (EPP) code, etc.) to the interested user. This code is required by the registrar of the interested user to approve and complete the transfer. The owner can obtain this code by requesting the code from their registrar, and once the interested user has the code, the interested user can initiate the transfer process on their own registrar platform.

The domain transfer process can endure from a few hours to several days. The standard transfer period is usually between five to seven days, but in some cases, it can take up to sixty days, depending on various factors. The sixty day waiting period is particularly relevant in cases where the domain was recently registered or transferred. According to the Internet Corporation for Assigned Names and Numbers (ICANN) rules, newly registered or recently transferred domains are subject to a sixty day lock period during which they cannot be transferred to another registrar. For example, if the Web2 domain was registered or transferred to the owner within the last sixty days, the owner may not be able to transfer the domain to the interested user until this lock expires. This policy is designed to reduce domain hijacking and fraudulent transfers.

Once the transfer is initiated and all necessary confirmations are made (e.g., the authorization code, the unlock status, etc.), the interested user receives a confirmation email from their registrar, and the domain is transferred to the account of the interested user. After the transfer is complete, the interested user can renew the domain or manage the domain within their registrar control panel.

Following a successful transfer, the new owner may need to update the domain WHOIS information (contact details) and may also establish domain privacy protection.

In addition, there may be transfer restrictions for Web2 domains. For example, some domain extensions may have specific rules or restrictions regarding transfers. By way of example, country-code top-level domains (ccTLDs) may have unique transfer requirements based on the country of registration.

Domain marketplaces and brokerage services for Web2 domains are members of the domain name economy and provide users with an efficient way to transfer domain names. While the process of transferring domains can be relatively straightforward, the existence of domain locks, the need for authorization codes, and the transfer waiting periods (e.g., a sixty day rule, etc.) are factors that can delay the final ownership change.

Accordingly, an embodiment of the present invention utilizes a blockchain to indicate transfer-less ownership changes for an offchain asset (e.g., Web2 domain or domain name, ICANN domain or domain name, Domain Name System (DNS) domain or domain name, etc.). For example, ownership of the offchain asset by a user may be indicated utilizing a blockchain without transfer of the actual offchain asset to the user. The transfer of the actual offchain asset may be deferred or delayed until requested by the user (and occur at a later time after the change in ownership), thereby enabling multiple ownership indication changes prior to transfer of the actual offchain asset. Thus, an ownership indication change may be performed without the time consuming processes of unlocking and use of authorization codes. By way of example, an onchain asset may be a non-fungible token (NFT) representing a corresponding onchain version of an offchain domain name (or tokenized version of the offchain domain name). An offchain domain name (e.g., Web2 domain or domain name, ICANN domain or domain name, Domain Name System (DNS) domain or domain name, etc.) may be tokenized as an NFT or other onchain representation by a blockchain service or smart contract. The onchain version may be transferred on a blockchain to change the ownership indication on the blockchain of the offchain domain name (e.g., an effective or constructive transfer of the offchain domain name without occurrence of an actual transfer of the offchain domain name on Web2).

An embodiment of the present invention utilizes blockchain technology to facilitate the transfer of a Domain Name System (DNS) (or Web2) domain name without the need for full transfer (e.g., no unlocking or authorization codes required) of a DNS domain name until a future state (e.g., request by a current owner or other event requiring DNS record updates, etc.). This separates payment for the rights to the domain from the verification of the records on ICANN to finalize the transaction (e.g., offchain settlement, etc.).

An embodiment of the present invention enables a domain marketplace to exchange Web2 domain names between owners (or other entities with rights to the domain name) and interested users without requiring traditional domain transfers. This can be offered as a service (e.g., application programming interfaces (APIs), etc.) to partners and other registrars.

Moreover, in order to transfer a Web2 domain to a new registrar, the user would have to extend expiration by one year. An embodiment of the present invention defers the extension cost until Domain Name System (DNS) or other records for the Web2 domain need to be updated (e.g., until the offchain DNS domain name has to be transferred to a new registrar).

Transfer of an onchain or offchain asset may include any action or transaction that provides ownership, rights, registration, custody, control, possession, and/or any other interest in the onchain or offchain asset. Further, acquiring or obtaining an onchain or offchain asset may include obtaining ownership, rights, registration, custody, control, possession, and/or any other interest in the onchain or offchain asset.

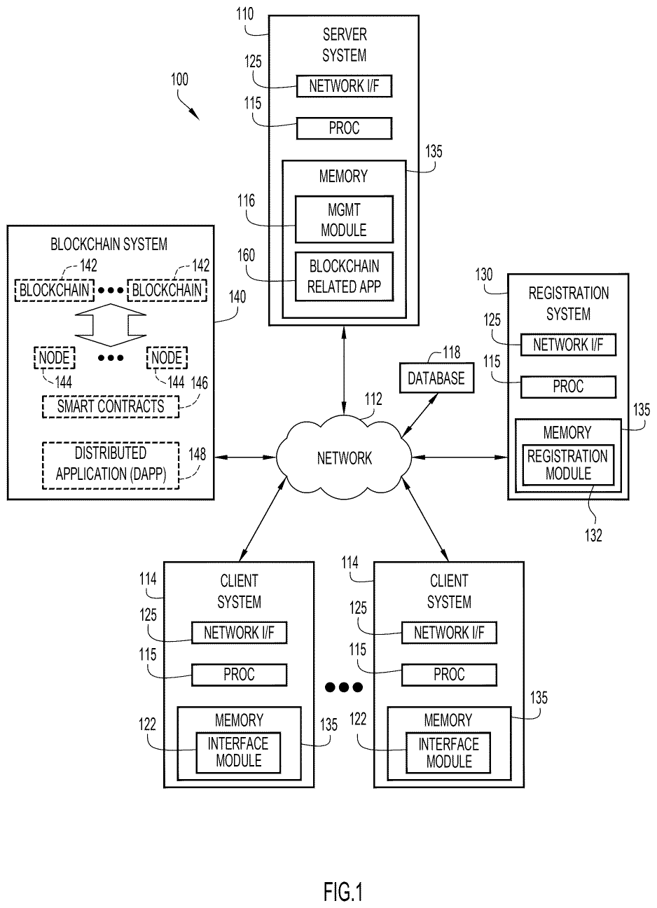

An example environment 100 for use with present invention embodiments is illustrated in FIG. 1. Specifically, environment 100 includes one or more server systems 110, one or more client or end-user systems 114, one or more registration systems 130, and one or more blockchain systems 140 each implementing and maintaining at least one corresponding blockchain 142. Server systems 110, client systems 114, registration systems 130, and/or blockchain systems 140 may be remote from each other and communicate over a network 112. The network may be implemented by any number of suitable communications media (e.g., wide area network (WAN), local area network (LAN), Internet, Intranet, etc.). Alternatively, server systems 110, client systems 114, registration systems 130, and/or blockchain systems 140 may be local to each other, and communicate via any appropriate local communication medium (e.g., local area network (LAN), hardwire, wireless link, Intranet, etc.).

Server systems 110 include a management module 116. Management module 116 may interface with a user via client system 114, and/or may be of the form of an Application Programming Interface (API) to perform onchain and/or offchain asset management (e.g., for domains or other objects, marketplace or other platforms, etc.). The management module may process requests from any entities (e.g., user, application, service, computing or other device, etc.).

Client systems 114 may include an interface module 122 to provide a graphical user (e.g., GUI, etc.) or other interface (e.g., command line prompts, menu screens, etc.) that enables users to access server systems 110 and blockchain systems 140 for managing onchain and/or offchain assets (e.g., domains or other objects, etc.). The interface module may include any conventional or other browser to access server systems 110 and blockchain systems 140.

Registration systems 130 include a registration module 132 that registers and manages names or other identifiers for offchain assets (e.g., Web2 domains or domain names, ICANN domains or domain names, Domain Name System (DNS) domains or domain names, etc.). By way of example, the registration system may include a conventional or other DNS server and be associated with one or more registrars.

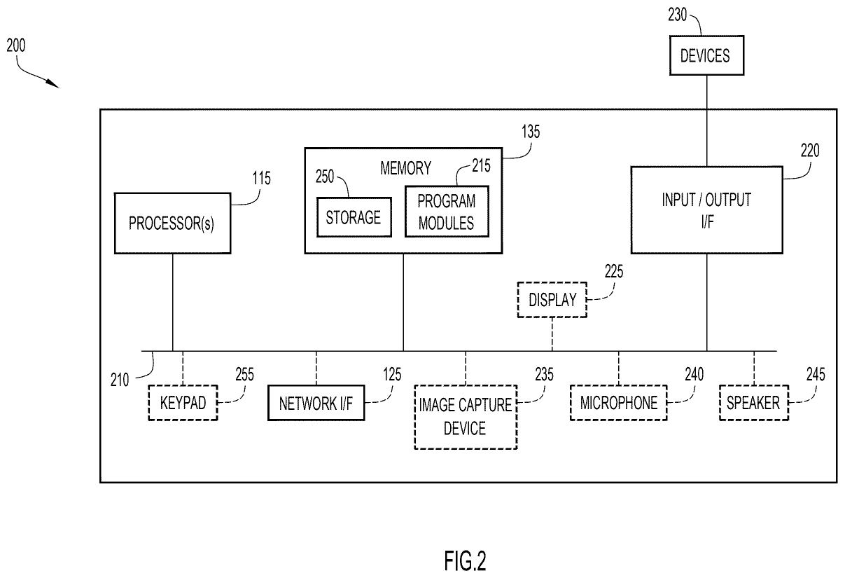

Blockchain systems 140 may each include one or more nodes 144 to implement and maintain at least one corresponding blockchain 142. The nodes may be implemented by any suitable computing devices (e.g., as described below for FIG. 2). The blockchain is generally in the form of a ledger that includes a series of records or blocks chained or linked together. The blockchain is typically managed by a peer-to-peer network (of nodes 144) and used as a distributed ledger. Nodes 144 of the peer-to-peer network communicate and verify new blocks according to a protocol. The peer-to-peer network provides a decentralized approach, where each node has a copy of a blockchain 142. Transactions are transmitted to the peer-to-peer network, where mining nodes (nodes 144) process the transactions. The mining nodes validate a transaction, insert the transaction into a current block, and transmit the block to the other nodes. Blockchain 142 may be implemented by any conventional or other blockchain, and may be a public (e.g., no access restrictions, etc.), private (e.g., restricted access, etc.), or hybrid (e.g., with centralized and decentralized features) blockchain.

Blockchain systems 140 may include one or more distributed or decentralized applications (dApps) 148 to perform various operations (e.g., financial or other transactions or operations related to a blockchain, etc.). In addition, a blockchain 142 may store software (e.g., typically referred to as smart contracts 146) that executes on the blockchain in response to occurrence of pre-defined conditions. The smart contracts may transfer onchain and/or offchain assets as described below. The onchain assets may be associated with the same and/or various different blockchains.

Interface module 122 of client systems 114 may further provide a graphical user (e.g., GUI, etc.) or other interface (e.g., command line prompts, menu screens, etc.) that enables users to access distributed applications (dApps) 148 and/or smart contracts 146 on blockchain systems 140 for performing various operations (e.g., financial or other transactions or operations related to a blockchain, etc.). The interface module may include any conventional or other browser to access the decentralized applications (dApps) of blockchain systems 140. The interface module may natively, or include extensions to, access the decentralized applications (dApps) and/or other components of blockchain system 140. The interface module may provide a user interface to serve as a front end for a decentralized application (dApp) 148, where back end processing for the decentralized application (dApp) is performed on a blockchain system 140. Client systems 114 may further provide reports or notifications pertaining to requests from users (e.g., results of a transaction, transfers of onchain and/or offchain assets, etc.).

Server systems 110 further include one or more blockchain related applications 160 for performing various operations (e.g., transactions or operations related to a blockchain, access asset information based on an associated asset, etc.). Management module 116 and blockchain related applications 160 may be on the same or different server systems 110. The blockchain related application may process requests from any entities (e.g., user, application, service, computing or other device, etc.).

A database or offchain storage system 118 may store various information for a blockchain asset (e.g., blockchain asset information, mappings of blockchain assets to blockchains, blockchain domain content, etc.). The database system may be implemented by any conventional or other database or offchain storage unit (e.g., Interplanetary File System (IPFS), etc.), may be local to or remote from server systems 110, client systems 114, registration systems 130, and/or blockchain systems 140, and may communicate via any appropriate communication medium (e.g., local area network (LAN), wide area network (WAN), Internet, hardwire, wireless link, Intranet, etc.).

Server systems 110, client systems 114, and registration systems 130 may be implemented by any conventional or other computer systems preferably equipped with a display or monitor, a base, optional input devices (e.g., a keyboard, mouse or other input device), and any software for use by present invention embodiments (e.g., server/communications software, blockchain software, management module 116, interface module 122, registration module 132, blockchain related applications 160, etc.). The base may include at least one hardware processor 115 (e.g., microprocessor, controller, central processing unit (CPU), etc.), one or more memories 135, and/or internal or external network interfaces or communications devices 125 (e.g., modem, network cards, etc.)).

Management module 116, interface module 122, registration module 132, smart contracts 146, decentralized applications (dApps) 148, and blockchain related applications 160 may include one or more modules or units to perform the various functions of present invention embodiments described below. The various modules (e.g., management module 116, interface module 122, registration module 132, blockchain related applications 160, etc.) may be implemented by any combination of any quantity of software and/or hardware modules or units, and may reside within memory 135 of the server, client, and/or registration systems for execution by a corresponding processor 115. The various modules of the blockchain (e.g., smart contracts 146, decentralized applications (dApps) 148, etc.) may be implemented by any combination of any quantity of software and/or hardware modules or units, and may reside on a blockchain 142 for execution by one or more nodes 144.

An example of a computing device 200 for environment 100 (e.g., implementing server systems 110, client systems 114, registration systems 130, blockchain systems 140, nodes 144, etc.) is illustrated in FIG. 2. The example computing device may perform the functions of present invention embodiments described herein. Computing device 200 may be implemented by any personal or other type of computer or processing system (e.g., desktop, laptop, hand-held device, smartphone or other mobile device, etc.), and may be used for any computing environments (e.g., cloud computing, client-server, network computing, mainframe, stand-alone systems, etc.).

Computing device 200 may include one or more processors 115 (e.g., microprocessor, controller, central processing unit (CPU), etc.), network interface 125, memory 135, a bus 210, and an Input/Output interface 220. Bus 210 couples these components for communication, and may be of any type of bus structure, including a memory bus or memory controller, a peripheral bus, and a processor or local bus using any of a variety of conventional or other bus architectures. Memory 135 is coupled to bus 210 and typically includes computer readable media including volatile media (e.g., random access memory (RAM), cache memory, etc.), non-volatile media, removable media, and/or non-removable media. For example, memory 135 may include storage 250 containing non-removable, non-volatile magnetic or other media (e.g., a hard drive, etc.). The computing device may further include a magnetic disk drive and/or an optical disk drive (not shown) (e.g., CD-ROM, DVD-ROM or other optical media, etc.) connected to bus 210 via one or more data interfaces.

Moreover, memory 135 includes a set of program modules 215 (e.g., corresponding to management module 116, interface module 122, registration module 132, blockchain software (e.g., smart contracts 146, decentralized applications (dApp) 148, blockchain management software, etc.), blockchain related applications 160, network site or service software, etc.) that are configured to perform functions of present invention embodiments described herein. The memory may further include an operating system, at least one application and/or other modules, and corresponding data. These may provide an implementation of a networking environment.

Input/Output interface 220 is coupled to bus 210 and communicates with one or more peripheral or external devices 230 (e.g., a keyboard, mouse or other pointing device, a display, sensing devices, etc.), at least one device that enables a user to interact with computing device 200, and/or any device (e.g., network card, modem, etc.) that enables computing device 200 to communicate with one or more other computing devices. Computing device 200 may communicate with one or more networks (e.g., a local area network (LAN), a wide area network (WAN), a public network (e.g., the Internet), etc.) via network interface 125 coupled to bus 210.

With respect to certain entities (e.g., client system 114, etc.), computing device 200 may further include, or be coupled to, a touch screen or other display 225, a camera or other image capture device 235, a microphone or other sound sensing device 240, a speaker 245 to convey sound, and/or a keypad or keyboard 255 to enter information (e.g., alphanumeric information, etc.). These items may be coupled to bus 210 or Input/Output interface 220 to transfer data with other elements of computing device 200.

Initially, a blockchain (e.g., blockchain 142, etc.) is generally in the form of a ledger that includes a series of records or blocks chained or linked together. Each block includes a hash of the prior block in the blockchain, a timestamp, and transaction information. The hash of the prior block enables the blockchain to be resistant to modification since changes to data in any prior block alter the hash value which propagates to subsequent blocks.

A blockchain is typically managed by a peer-to-peer network and used as a distributed ledger. Nodes of the peer-to-peer network communicate and verify new blocks according to a protocol. The peer-to-peer network provides a decentralized approach, where each node has a copy of the blockchain. Transactions are transmitted to the network, where mining nodes process the transactions. The mining nodes validate a transaction, insert the transaction into a current block, and transmit the block to the other nodes. Various consensus approaches may be used for combining validation results of different mining nodes to determine validity of a transaction (or block).

Users of transactions for the blockchain are authenticated based on cryptographic keys. These keys identify a user and provide access to a user wallet. The user wallet is basically an application or software that enables users to store and access digital assets (e.g., for receiving or sending cryptocurrency or other fungible tokens, non-fungible tokens (NFTs), etc.). For example, a non-fungible token (NFT) is a crypto type asset with each token being unique (and representing items, such as digital art, music, or video game items), whereas fungible tokens (e.g., coins of the same cryptocurrency) have the same value of worth and are exchangeable. Each user is associated with their own private key (e.g., accessible only to the associated user, etc.) and a public key (e.g., typically an address on the blockchain). The private and public keys enable authentication of the user based on digital signatures in order to commence a transaction. The user wallet typically stores the private key.

For example, in order for the user to send cryptocurrency, a message for a transaction is encrypted (or signed) using the private key of the user wallet. The private key enables only the user to control the user wallet. A digital signature is created by encrypting the message with the private key, where the digital signature is used to verify the user and transaction. The message may be decrypted with the corresponding public key of the user wallet. Since the private key is unique to the user, successful decryption of the message with the corresponding public key verifies the message was sent by the user. Once verified, the transaction may be posted to the blockchain, thereby adjusting the user account based on the transaction.

In addition, a blockchain may store software (e.g., smart contracts 146) that executes in response to occurrence of pre-defined conditions. A smart contract is generally software or a program that runs on the blockchain. The code and data for the smart contract reside at a specific address on the blockchain. Non-fungible tokens (NFTs) are controlled by smart contracts that handle transference and verification of ownership of the non-fungible tokens (NFTs). A blockchain may be public (e.g., no access restrictions, etc.), private (e.g., restricted access, etc.), or hybrid (e.g., with centralized and decentralized features).

A blockchain domain name is stored on a blockchain. A blockchain domain name may be a non-fungible token (NFT) domain name that is associated with a non-fungible token (NFT) stored in a user wallet account. The blockchain domain name may be associated with various information (e.g., wallet addresses or accounts, user information (e.g., name, address, email, etc.), data or other access restrictions, etc.). The blockchain domain name is associated with software or smart contracts on the blockchain that may perform various functions (e.g., provide a registry for corresponding wallet addresses, indicate locations of content for the domain (e.g., or a website, etc.) hosted on the blockchain or other system, etc.). In order to access a blockchain domain, the blockchain is accessed to find the record corresponding to the blockchain domain name (which may initiate the corresponding smart contracts for the corresponding functionality). The private key of the user wallet enables the user to have sole control of the blockchain domain (e.g., authenticating operations or transactions for the blockchain domain name similar to the cryptocurrency example described above, etc.). For example, the user may have sole control to perform operations that alter content and/or functionality for the blockchain domain.

An embodiment of the present invention utilizes blockchain technology to facilitate the transfer of a Domain Name System (DNS) (or Web2) domain name without the need for full transfer (e.g., no unlocking or authorization codes required) of a DNS domain name until a future state (e.g., current owner request or other event requiring updates of DNS record). This separates payment for the rights to the domain from the verification of the records on ICANN to finalize the transaction (e.g., offchain settlement, etc.). An offchain domain name (e.g., Web2 domain or domain name, ICANN domain or domain name, Domain Name System (DNS) domain or domain name, etc.) may be tokenized as an NFT or other onchain representation by a blockchain service or smart contract. The onchain version may be transferred to change an ownership indication on the blockchain of the offchain domain name (e.g., an effective or constructive transfer of the offchain domain name without occurrence of an actual transfer of the offchain domain name on Web2).

Transfer of an onchain or offchain asset may include any action or transaction that provides ownership, rights, registration, custody, control, possession, and/or any other interest in the onchain or offchain asset. Further, acquiring or obtaining an onchain or offchain asset may include obtaining ownership, rights, registration, custody, control, possession, and/or any other interest in the onchain or offchain asset.

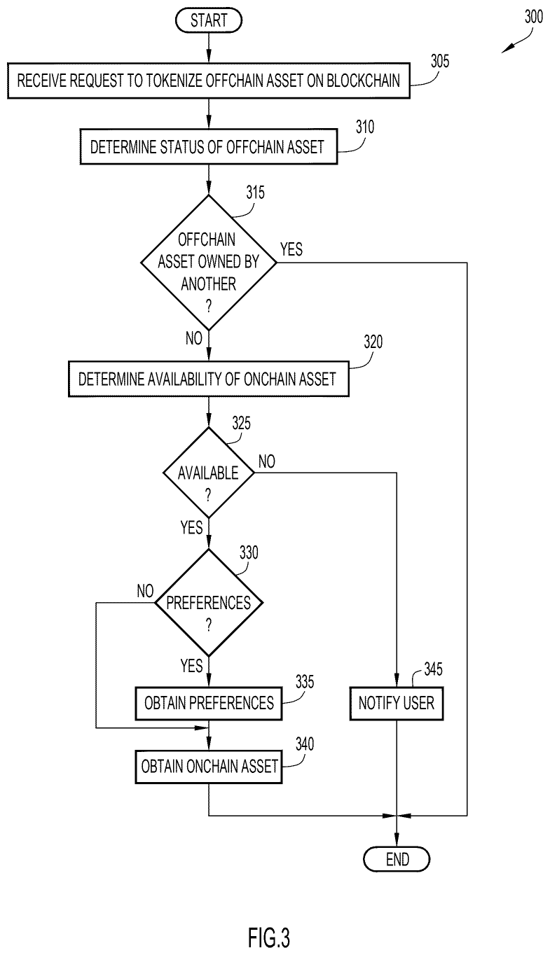

A method 300 of registering a name or other identifier for an onchain asset (e.g., Web3, blockchain, etc.) based on a name or other identifier for an offchain asset (e.g., Web2, Domain Name System (DNS), etc.) (e.g., via management module 116, registration module 132, smart contract 146, distributed application (dApp) 148, blockchain related application 160, server system 110, client system 114, registration system 130, and/or blockchain system 140) according to an embodiment of the present invention is illustrated in FIG. 3. Initially, a user may register, or desire to register, a name or other identifier of an offchain asset (e.g., Web2, ICANN, Domain Name System (DNS), etc.) for an onchain asset (e.g., Web3, blockchain, non-fungible token (NFT), etc.) via management module 116. An asset may include any item or object associated with a computer or network environment (e.g., a domain, a domain name, a set of records, an object that points to a set of records, a non-fungible token (NFT), non-fungible token (NFT) domain names, a fungible token, a wallet address, email or other service, communication entity, etc.). An onchain asset may include any asset residing on, or supported by, a blockchain or other decentralized system (e.g., Web3 asset, asset of a decentralized system, asset of a partial or hybrid decentralized system, etc.). An offchain asset may include any asset residing on, or supported by, a centralized system or a system with centralized control (e.g., Web2, Domain Name System (DNS), system other than a decentralized system described above, etc.). The name or other identifier for the offchain and onchain assets may include a name portion and an optional extension (e.g., “name.e1”, etc.). Alternatively, the name or other identifier may include the name portion without the extension. The name portion and extension may each include any quantity of terms, words, tokens, or arrangements of any quantity of any types of elements (e.g., alphanumeric or other characters, symbols, numbers, etc.). A user may include, or be associated with, any type of entity (e.g., individual, company, organization, decentralized autonomous organization (DAO), etc.).

Management module 116 receives a request for the name or other identifier of the offchain asset to tokenize (or create a corresponding non-fungible token (NFT) for) the offchain asset on a blockchain at operation 305. The management module may receive and process requests from any entities (e.g., user, application, service, computing or other device, client system 114, etc.). The management module performs a look-up of the name of the offchain asset at operation 310 to determine registration/ownership of the offchain asset by another user (e.g., indicating unavailability of the offchain asset). By way of example, the offchain asset may include an offchain domain name (e.g., Web2, Domain Name System (DNS), etc.), and management module 116 requests information (e.g., DNS records, etc.) for the offchain domain name from registration system 130. The information from the registration system indicates registration/ownership or availability of the offchain asset.

When the offchain asset is not registered/owned by another user as determined at operation 315, management module 116 determines availability of the name of the offchain asset for an onchain asset at operation 320. In other words, management module determines availability of an onchain representation of the offchain asset. For example, the management module (e.g., via blockchain related application 160) accesses an intended blockchain 142 for the onchain version (e.g., via a blockchain system 140), and performs a look-up for the name of the offchain asset on the blockchain. Absence of a record on the blockchain for the name indicates the name for the offchain asset (or onchain version) is available on the blockchain. Further, management module 116 may perform a look-up for the name (e.g., on a blockchain, marketplace, etc.) to determine availability of the onchain asset for transfer from another user. The intended blockchain may be selected by a user, and the name for the look-up may include the name portion of the name of the offchain asset (e.g., with the same extension, a corresponding extension for the intended blockchain, etc.).

When an onchain representation of the offchain asset is available as determined at operation 325, payment and other preferences may be provided or selected for acquiring the onchain version (e.g., tokenizing the offchain asset on the blockchain). The options or preferences may include payment to acquire the onchain representation, an intended blockchain or other system to publish or mint the onchain version, a smart contract for the transaction, etc. When preferences are required as determined at operation 330, management module 116 obtains the preferences at operation 335. The preferences may be stored offchain in database system 118, or received from an administrator.

The name for the onchain version is acquired at operation 340. For example, management module 116 (e.g., via blockchain related application 160, corresponding smart contract 146, and/or distributed application (dApp) 148) publishes or mints the name for the onchain version (e.g., represented by a non-fungible token (NFT)) on a corresponding blockchain, and/or transfers the onchain asset from a current owner to the user (e.g., places the onchain asset in a user wallet account). The acquisition of the onchain version may be performed based on any required preferences. This may be accomplished by management module 116 (e.g., via blockchain related application 160, corresponding smart contract 146, and/or distributed application (dApp) 148) providing a transaction to the blockchain indicating acquisition of the onchain version (or NFT) by the user. In addition, various information for the onchain version (e.g., user information, asset information, wallet information, etc.) may be stored onchain and/or in offchain storage (e.g., database system 118, etc.).

The offchain and onchain versions may be linked based on the name or other identifier. For example, management module 116 (e.g., via registration module 132 of registration system 130) may set a record associated with the offchain asset to indicate the onchain representation. By way of example, a Domain Name System (DNS) canonical name or other record may be created or modified to include an identifier for the onchain asset (e.g., onchain domain name, wallet address, etc.).

Further, management module 116 (e.g., via decentralized application (dApp) 148 and/or blockchain related application 160) may set or update records associated with the onchain asset to indicate information for the offchain asset. For example, an onchain or offchain record may be created or modified to include an identifier for the offchain asset (e.g., an offchain domain name to be linked, IP address, registry, etc.).

Once the onchain and offchain representations are acquired, transactions may be conducted (e.g., via management module 116 and/or blockchain related application 160) using the names for the onchain or offchain assets. For example, the information in the records for the offchain domain may be used to resolve data for the onchain representation (e.g., a user may send cryptocurrency to an offchain domain (based on an associated record indicating the onchain domain), etc.). The transaction may be analyzed to determine the actions, underlying system, and the corresponding representation needed for that system. By way of example, when the transaction is for an onchain representation (or domain) for an onchain system using an offchain representation (or domain), a lookup of the Domain Name System (DNS) canonical name or other record associated with the offchain representation (e.g., Web2/offchain/DNS version of the onchain domain) is performed to obtain the onchain representation for conducting the transaction. A similar approach may be used for offchain transactions using onchain representations.

Further, transactions conducted for an onchain or offchain representation may automatically be applied to the linked (offchain or onchain) representation. By way of example, selling an offchain representation also sells the linked onchain representation (and vice versa), transferring the onchain representation also transfers the linked offchain representation (and vice versa), making available for auction the onchain representation also makes the linked offchain representation available (and vice versa), purchasing an offchain representation brand new also purchases the linked onchain representation (and vice versa), taking out a loan may apply to the linked representations or be conducted using one of the linked representations, extending expiration of (or renewing) an offchain representation extends (or renews) the registration for a linked onchain representation (and vice versa), and/or transferring an offchain domain to a new registrar (in the case of domains) transfers the onchain domain to the new registrar (or vice versa) or the transfer may be conducted using one of the linked representations.

When the onchain asset is not available based on the look-up (e.g., an onchain representation of the offchain asset is already owned by the user or by another user that is not making the onchain asset available for transfer) as determined at operation 325, management module 116 alerts or notifies the user at operation 345. The notification may indicate ownership information for the onchain version of the offchain asset (e.g., the user or other user owning the onchain asset, etc.), and may be presented on a client system 114 (e.g., via interface module 122, etc.).

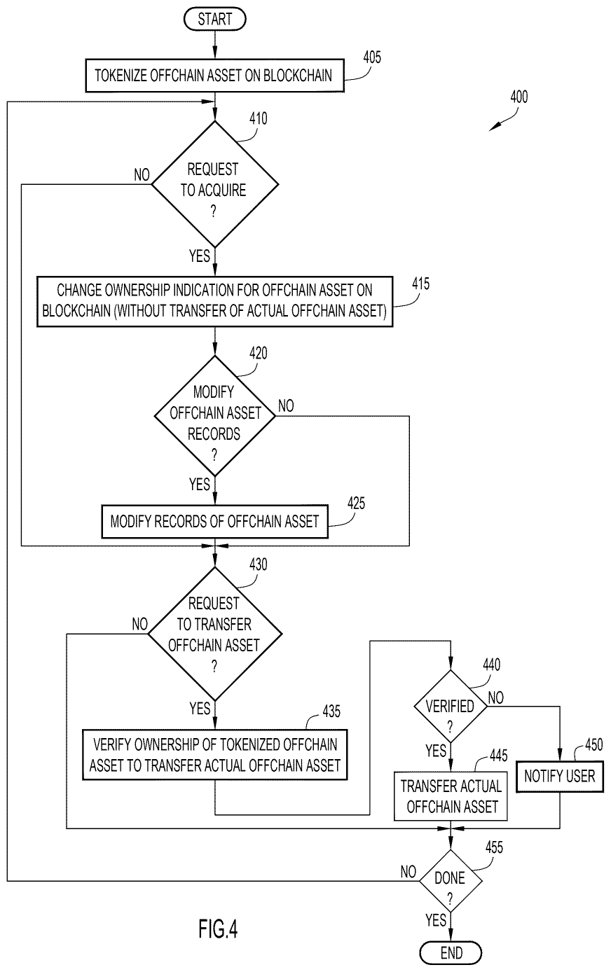

A method 400 of transferring an offchain asset between users utilizing a blockchain (e.g., via management module 116, registration module 132, smart contract 146, decentralized application (dApp) 148, blockchain related application 160, server system 110, client system 114, registration system 130, and/or blockchain system 140) according to an embodiment of the present invention is illustrated in FIG. 4. By way of example, method 400 is described with respect to an offchain asset including a Web2, ICANN, or Domain Name System (DNS) domain or domain name and an onchain asset representing the offchain asset by a non-fungible token (NFT). However, any onchain and offchain assets may be used in substantially the same manner described below.

An offchain asset (e.g., Web2 domain or domain name, ICANN domain or domain name, Domain Name System (DNS) domain or domain name, etc.) is tokenized on a blockchain (e.g., via management module 116, smart contract 146, decentralized application (dApp) 148, blockchain related application 160, etc.) at operation 405. Initially, a request to tokenize the offchain asset is issued from an initial user via a client system 114 to smart contract 146 (e.g., via management module 116, decentralized application (dApp) 148, blockchain related application 160, etc.). The initial user may be any entity owning or otherwise having rights to the offchain asset. The tokenization may be requested by any entity, such as an owner of the offchain asset, a registrar, a domain broker, a domain marketplace, etc.

A tokenized (or onchain) version of the offchain asset is created (e.g., via management module 116, smart contract 146, decentralized application (dApp) 148, blockchain related application 160, etc.). Once the tokenized version is created, a domain owner may be changed to a registrar (as opposed to an individual). For example, management module 116 may tokenize the offchain asset for the initial user on a blockchain in substantially the same manner described above (FIG. 3). The tokenization may include minting or publishing a non-fungible token (NFT) representing the offchain asset on the blockchain, and/or transferring the NFT from a previous owner to the initial user (e.g., places the onchain asset corresponding to the offchain asset in a user wallet account) via the smart contract. A user may include, or be associated with, any type of entity (e.g., individual, company, organization, etc.). Transfer of an onchain or offchain asset may include any action or transaction that provides ownership, rights, registration, custody, control, possession, and/or any other interest in the onchain or offchain asset. Further, acquiring or obtaining an onchain or offchain asset may include obtaining ownership, rights, registration, custody, control, possession, and/or any other interest in the onchain or offchain asset.

The initial user may request (via client system 114) that smart contract 146 list the offchain asset as available for a transaction (e.g., on a domain marketplace or other platform via management module 116) to enable another user to obtain the offchain asset. Alternatively, a direct request to another user may be issued to the smart contract.

When a request is received from a user to acquire the offchain asset as determined at operation 410, a transaction is conducted to change an ownership indication for the offchain asset on the blockchain from the initial user to the acquiring user (e.g., via management module 116, smart contract 146, decentralized application (dApp) 148, blockchain related application 160, etc.) at operation 415 (without transfer of the actual offchain asset to the acquiring user). An acquiring user may include, or be associated with, any type of entity (e.g., individual, company, organization, etc.). For example, the acquiring user may send a request to acquire the offchain asset (via a client system 114) to smart contract 146 (e.g., via management module 116, decentralized application (dApp) 148, blockchain related application 160, etc.). The acquiring user may be required to enter their contact information. For example, ICANN requires WHOIS data to correctly reflect the owner. The acquiring user may become the owner and, therefore, may need to provide their contact information pre-emptively.

Once the request is approved by the initial user (via client system 114), smart contract 146 transfers the tokenized (or onchain) version of the offchain asset to the acquiring user. The transfer may be accomplished by providing a transaction to the blockchain in substantially the same manner described above (FIG. 3). For example, management module 116 (e.g., via blockchain related application 160, smart contract 146, and/or distributed application (dApp) 148) transfers the tokenized offchain asset to the acquiring user (e.g., places the onchain asset corresponding to the offchain asset in a wallet account of the acquiring user). The acquisition of the onchain version may be performed based on any required preferences. This may be accomplished by management module 116 (e.g., via blockchain related application 160, smart contract 146, and/or distributed application (dApp) 148) providing a transaction to the blockchain indicating acquisition of the onchain version (or NFT) by the acquiring user. In addition, various information for the onchain version (e.g., user information, asset information, wallet information, etc.) may be stored onchain and/or in offchain storage (e.g., database system 118, etc.).

In some cases, Domain Name System (DNS) or other records for the offchain asset may be modified to suspend a domain and/or provide notifications (e.g., based on user or registrar preferences, etc.). When the DNS or other records are to be modified as determined at operation 420, the DNS or other records may be modified (e.g., via management module 116, registration module 132 of registration system 130, etc.) to perform desired actions. By way of example, DNS or other records for the offchain asset may be cleared by registration system 130. For example, the records may include WHOIS records that would have otherwise indicated that the contact information for the offchain asset is that of the initial user. This may prevent abuse, where a user establishes a domain for improper content and transfers the onchain asset to a dead address to prevent updating. Accordingly, an administrator of the onchain registry can revoke onchain assets whenever necessary (e.g., via management module 116, smart contract 146, and/or blockchain related application 160). By way of example, conditions of abuse may be detected (e.g., improper content, notifications, etc.), and the corresponding onchain asset may be revoked (e.g., transferred to the prior owner or to an escrow or holding wallet, etc.).

Alternatively, the DNS or other records may be frozen by registration system 130 so that neither the initial user nor the acquiring user may change the records until the initial user or acquiring user can validate ownership of the onchain version as described below. For example, when an onchain asset is transferred, a previous owner of the offchain asset may no longer be able to make updates to offchain asset records (e.g., the previous owner is no longer able to transfer an offchain domain to a new registrar, etc.). A new owner of the onchain asset can not make updates to the offchain asset until the onchain asset is properly verified. In other words, the records are frozen at the time of transfer of the onchain asset, and the previous owner can not make changes to the DNS records while they do not have the onchain asset. This is to prevent abuse, where someone could sell an offchain domain on the blockchain and transfer the offchain domain to a different registrar, thereby preventing a buyer from obtaining the purchased offchain domain. A new owner of the onchain asset proves ownership of the onchain asset as described below in order to gain management control access to the offchain asset. By way of further example, a landing page may be provided with an ownership or operational status for a domain, name servers may be changed, etc. to freeze the records. Since a transfer of the offchain asset is not requested or required at this point, unlocking or acquiring an authorization code is also not required.

In addition, during onchain transfer of ownership of the onchain asset, the Domain Name System (DNS) or other records for the offchain asset may be modified by a registrar. For example, the registrar may update the contact information to reflect the new ownership as well as modify the name servers. This may be useful to provide a landing page showing a status that a domain is owned, but may not yet serve as a custom website.

The ownership indication for the offchain asset indicates the acquiring user on the blockchain, while the actual offchain asset remains untransferred (and typically with the initial user) until the acquiring user requests transfer of the actual offchain asset (or other event occurs) requiring update of the DNS or other records. Accordingly, the above process may be repeated from operation 410 to transfer the onchain asset from the acquiring user to one or more additional users (e.g., an effective or constructive transfer of the offchain asset while the actual offchain asset remains with the initial user) in substantially the same manner described above until a request to transfer the actual offchain asset is received as determined at operation 430 or the process terminates as determined at operation 455 (e.g., power down, processing complete, etc.).

For example, a user currently having ownership of the offchain asset (as indicated on the blockchain) may request that the offchain asset be listed (e.g., on a domain marketplace or other platform via management module 116) as available in substantially the same manner described above. The above process may repeatedly transfer the onchain asset to one or more additional users (e.g., an effective or constructive transfer of the offchain asset while the actual offchain asset remains with the initial user). This enables immediate changes to ownership indications on the blockchain for the offchain asset (e.g., an effective or constructive transfer of the offchain asset) without requiring the time consuming processes of unlocking and use of authorization codes.

A current user acquiring constructive ownership of the offchain asset may desire to transfer the actual offchain asset from the initial user to the current acquiring user. For example, the current acquiring user may desire to modify the DNS or other records of the offchain asset to perform the transfer. When a request to transfer the offchain asset is received as determined at operation 430, the ownership of the tokenized (or onchain) version is verified at operation 435. For example, the current acquiring user may send a request to registration system 130 (e.g., via client system 114 and management module 116) and a domain validation management layer of the registration system processes a validation request in order to modify the DNS records. For example, the validation may include verifying the tokenized version of the offchain asset is owned or in custody of the current acquiring user.

The validation may be accomplished by registration system 130 sending a request to smart contract 146 to check the wallet account of the current acquiring user in combination with a blockchain signature. For example, the smart contract may access a wallet account of the current acquiring user based on credentials provided by the current acquiring user, where the wallet account includes the onchain assets of the current acquiring user. Smart contract 146 examines the onchain assets of the wallet account and determines a presence of the tokenized version of the offchain asset within the wallet account. By way of example, the onchain assets of the wallet account may be determined by searching transactions on a corresponding blockchain indicating acquisition of onchain assets by the wallet account. The presence of the tokenized version of the offchain asset may be determined based on the names and/or extensions of the onchain assets and/or records of the onchain assets indicating corresponding offchain versions.

In addition, the current acquiring user may sign a message (e.g., via a client system 114 and initiated via smart contract 146 through management module 116, decentralized application (dApp) 148, blockchain related application 160, etc.) with the same wallet account containing the onchain asset (or tokenized offchain asset) to confirm acquisition of the onchain asset by the current acquiring user. By way of example, signing of the message in a crypto wallet account (e.g., custodied, self-custody, etc.) generates a digital signature of the message based on the private key of the wallet account. The signed message or digital signature is decrypted for verification (e.g., by an add-on or plug-in of interface module 122 of client system 114) based on a public key (e.g., blockchain address, etc.) corresponding to the wallet account. Since the private key is unique to the wallet account, successful decryption of the message with the corresponding public key verifies the message was sent by the current acquiring user. The current acquiring user may sign a message with the same wallet account containing the onchain asset (or tokenized offchain asset) to confirm acquisition of the onchain asset by the current acquiring user. A response may be provided (e.g., from the add-on or plug-in of interface module 122) indicating a result of the decryption of the signed message which may be sent to smart contract 146 (e.g., via management module 116, decentralized application (dApp) 148, blockchain related application 160, etc.).

Smart contract 146 sends a notification to registration system 130 (e.g., via management module 116, decentralized application (dApp) 148, blockchain related application 160, etc.) indicating ownership verification. In addition, the current acquiring user may be verified to comply with offchain asset regulations prior to the offchain asset being transferred to the acquiring user (e.g., entering and verifying an email address, etc.).

When validation fails (e.g., the current acquiring user does not possess the tokenized version of the offchain asset, the blockchain signature is invalid, and/or offchain asset regulations are violated) as determined at operation 440, the request to modify the DNS or other records is rejected, and an error message may be shown to the current acquiring user (via client system 114) at operation 450. The above process repeats from operation 410 until the process terminates (e.g., power down, processing complete, etc.) as determined at operation 455.

When the validation is successful (e.g., the current acquiring user does possess the tokenized version of the offchain asset, the blockchain signature is valid, any offchain asset regulations are satisfied, etc.), DNS or other records may be edited at the current registrar to transfer the actual offchain asset to the current acquiring user (using the same registrar) at operation 445.

Alternatively, a request for the offchain asset to be transferred (to a new registrar) may be sent from registration system 130 to client system 114 of the initial user. The initial user performs the transfer process (e.g., with respect to unlocking and authorization codes) for management of the offchain asset in a new registrar. The offchain asset may be transferred to a registrar of choice of the current acquiring user. When the contact information was not set, the contact information (for the current acquiring user) may be required as part of the transfer process for the offchain asset and provided by the current acquiring user (via client system 114) to registration system 130.

In addition, escrow functionality may be used to prevent distribution of funds, onchain assets, and/or offchain assets until participants of a transfer transaction are satisfied. For example, a smart contract 146 may be configured with a contract specifying terms of the transfer transaction (e.g., assets, funds/payments, etc.) to serve as an escrow and control transfer of various items. When the contract terms are satisfied, the items are transferred. The smart contract may be associated with wallet accounts to receive and store the items of a transaction (e.g., cryptocurrency, onchain assets, etc.) for transfer to the appropriate participants.

Accordingly, the ownership of the offchain asset may be effectively or constructively transferred to or between any quantity of users (as indicated on the blockchain), while transfer of the actual offchain asset is deferred or delayed until a current acquiring user requests transfer of the actual offchain asset (or other event occurs) requiring update of DNS or other records for the offchain asset. During the deferral or delay, the offchain asset remains with one of the prior owners (the initial user or an additional user that requested transfer of the actual offchain asset). Thus, the above process may be repeated from operation 410 to constructively transfer ownership of the offchain asset and defer or delay transfer of the actual offchain asset until requested in substantially the same manner described above until the process terminates (e.g., power down, processing complete, etc.) as determined at operation 455. This enables immediate changes to the ownership indication on the blockchain for the offchain asset to users (e.g., an effective or constructive transfer of the offchain asset) without requiring the time consuming processes of unlocking and use of authorization codes.

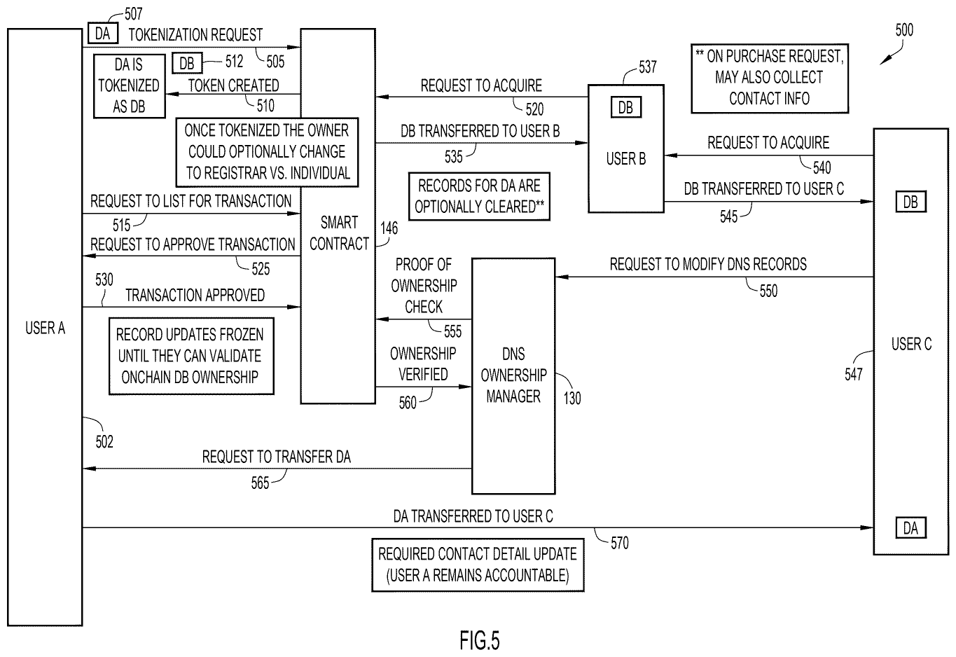

A method 500 of transferring an offchain asset between users utilizing a blockchain (e.g., via management module 116, registration module 132, smart contract 146, decentralized application (dApp) 148, blockchain related application 160, server system 110, client system 114, registration system 130, and/or blockchain system 140) according to an embodiment of the present invention is illustrated in FIG. 5. By way of example, method 500 is described with respect to an offchain asset including a Web2, ICANN, or Domain Name System (DNS) domain or domain name and an onchain asset representing the offchain asset by a non-fungible token (NFT). However, any onchain and offchain assets may be used in substantially the same manner described below.

Initially, a request to tokenize a DNS domain 507 (e.g., DA as viewed in FIG. 5) is issued from a user 502 (e.g., User A as viewed in FIG. 5) via a client system 114 to smart contract 146 (e.g., via management module 116, decentralized application (dApp) 148, blockchain related application 160, etc.) at flow 505. The tokenization may be requested by an owner of the domain, a registrar, a domain broker, a domain marketplace, etc.

A tokenized (or onchain) version of domain 507 (DA) is created as domain 512 (e.g., DB as viewed in FIG. 5) at flow 510 (e.g., via management module 116, smart contract 146, decentralized application (dApp) 148, blockchain related application 160, etc.). Once the tokenized version is created, the owner may change to a registrar (as opposed to an individual). For example, management module 116 may tokenize an offchain asset (e.g., Web2 domain or domain name, ICANN domain or domain name, Domain Name System (DNS) domain or domain name, etc.) for user 507 (User A) on a blockchain in substantially the same manner described above (FIG. 3). The tokenization may include minting or publishing a non-fungible token (NFT) representing the offchain asset on the blockchain, and/or transferring the NFT from a current owner to the user (e.g., places the onchain asset in a user wallet account) via the smart contract. A user may include, or be associated with, any type of entity (e.g., individual, company, organization, etc.). Transfer of an onchain or offchain asset may include any action or transaction that provides ownership, rights, registration, custody, control, possession, and/or any other interest in the onchain or offchain asset. Further, acquiring or obtaining an onchain or offchain asset may include obtaining ownership, rights, registration, custody, control, possession, and/or any other interest in the onchain or offchain asset.

User 502 (User A) requests (via client system 114) that smart contract 146 list domain 512 (DA) as available for a transaction for acquisition at flow 515 in substantially the same manner described above. Alternatively, a direct request to another user to acquire domain 512 (DA) may be issued to the smart contract.

A second user 537 (e.g., User B as viewed in FIG. 5) desires to acquire domain 507 (DA) and sends a request to acquire domain 507 (DA) (via a client system 114) to smart contract 146 (e.g., via management module 116, decentralized application (dApp) 148, blockchain related application 160, etc.) at flow 520. User 537 (User B) may be required to enter their contact information. For example, ICANN requires WHOIS data to correctly reflect the owner. User 537 (User B) may become the owner and, therefore, may need to provide their contact information pre-emptively.

Smart contract 146 sends a request to client system 114 of user 502 (User A) (e.g., via management module 116, decentralized application (dApp) 148, blockchain related application 160, etc.) to approve the acquisition request at flow 525. User 502 (User A) sends approval of the request via client system 114 to smart contract 146 (e.g., via management module 116, decentralized application (dApp) 148, blockchain related application 160, etc.) at flow 530. Smart contract 146 transfers domain 512 (DB) (or the tokenized version of domain 507 (DA)) to user 537 (User B) at flow 535.

The transfer may be accomplished by providing a transaction to the blockchain in substantially the same manner described above (FIG. 3). For example, smart contract 146 transfers the onchain asset (e.g., domain 512 (DB)) to the user (e.g., places the onchain asset corresponding to domain 512 (DB) in a user wallet account). The acquisition of the onchain version may be performed based on any required preferences. This may be accomplished by smart contract 146 providing a transaction to the blockchain indicating acquisition of the onchain version (or NFT) by the user. In addition, various information for the onchain version (e.g., user information, asset information, wallet information, etc.) may be stored onchain and/or in offchain storage (e.g., database system 118, etc.).

Domain Name System (DNS) or other records for domain 507 (DA) may be cleared by DNS ownership manager 130 (e.g., corresponding to registration system 130). For example, the records may include WHOIS records that would have otherwise indicated that the contact information for domain 507 (DA) is user 502 (User A). Alternatively, DNS records may be frozen at this point by DNS ownership manager 130 so that neither user 507 (User A) nor user 537 (User B) may change the records until they can validate ownership of onchain domain 512 (DB) as described below. For example, a landing page may be provided, name servers may be changed, etc. to freeze the records. Since a transfer of domain 507 (DA) (on Web2) is not requested or required at this point, unlocking or acquiring an authorization code is also not required.

In addition, during onchain transfer of ownership of the onchain version, the offchain DNS or other records may be modified by a registrar. For example, the registrar may update the contact information to reflect the paid ownership as well as modify the name servers. This may be useful to provide a landing page showing that a domain is owned, but may not yet serve as a custom website.

User 537 (User B) may request that domain 507 (DA) be listed as available in substantially the same manner described above. A third user 547 (e.g., User C as viewed in FIG. 5) desires to acquire domain 507 (DA) from user 537 (User B), and sends a request (via a client system 114) to client system 114 of user 537 (User B) (e.g., via management module 116, etc.) at flow 540. User 537 (User B) (now the rightful owner of domain 512 (DB)) approves the request and enables transfer of domain 512 (DB) (tokenized version of domain 507 (DA)) to user 547 (User C) at flow 545. The transfer may be accomplished by providing a transaction to the blockchain in substantially the same manner described above.

User 547 (User C) desires to modify the Domain Name System (DNS) or other records of domain 507 (DA) to transfer domain 507 (DA), and sends a request to DNS ownership manager 130 via client system 114 at flow 550. A domain validation management layer of the DNS ownership manager processes a validation request in order to modify the DNS or other records. For example, the validation may include verifying domain 512 (DB) (the tokenized version of domain 507 (DA)) is in custody of user 547 (User C) requesting validation.

The validation may be accomplished by DNS ownership manager 130 sending a request to smart contract 146 to check the wallet account of user 547 (User C) in combination with a blockchain signature at flow 555. For example, the smart contract may access the wallet account of user 547 (User C) based on credentials provided by user 547 (User C), where the wallet account includes the onchain assets acquired by user 547 (User C). Smart contract 146 examines the onchain assets of the wallet account and determines a presence of domain 512 (DB) (the tokenized version of domain 507 (DA)) within the wallet account. By way of example, the onchain assets of the wallet account may be determined by searching transactions on a corresponding blockchain indicating acquisition of onchain assets by the wallet account. The presence of domain 512 (DB) may be determined based on the names and/or extensions of the onchain assets and/or records of the onchain assets indicating corresponding offchain versions.

In addition, user 547 (User C) may sign a message (e.g., via a client system 114 and initiated via smart contract 146 through management module 116, decentralized application (dApp) 148, blockchain related application 160, etc.) with the same wallet account containing the onchain asset (or tokenized offchain asset) to confirm acquisition of the onchain asset by user 547 (User C). By way of example, signing of the message in a crypto wallet account (e.g., custodied, self-custody, etc.) generates a digital signature of the message based on the private key of the wallet account. The signed message or digital signature is decrypted for verification (e.g., by an add-on or plug-in of interface module 122 of client system 114) based on a public key (e.g., blockchain address, etc.) corresponding to the wallet account. Since the private key is unique to the wallet account, successful decryption of the message with the corresponding public key verifies the message was sent by user 547 (User C). User 547 (User C) may sign a message with the same wallet account containing the onchain asset (or tokenized offchain asset) to confirm acquisition of the onchain asset by user 547 (User C). A response may be provided (e.g., from the add-on or plug-in of interface module 122) indicating a result of the decryption of the signed message which may be sent to smart contract 146 (e.g., via management module 116, decentralized application (dApp) 148, blockchain related application 160, etc.).

Smart contract 146 sends a notification to DNS ownership manager 130 (e.g., via management module 116, decentralized application (dApp) 148, blockchain related application 160, etc.) indicating ownership verification at flow 560. When validation fails (e.g., user 547 (User C) does not possess domain 512 (DB) or the blockchain signature is invalid), the request to modify the DNS or other records is rejected, and an error message may be shown to user 547 (User C) (via client system 114). When the validation is successful (e.g., user 547 does possess domain 512 (DB) and the blockchain signature is valid), DNS or other records may be edited for transfer of domain 507 (DA) at the current registrar, or a request for domain 507 (DA) to be transferred to a new registrar is sent from DNS ownership manager 130 to the client system of user 502 (User A) at flow 565.

User 502 (User A) performs the transfer process (e.g., with respect to unlocking and authorization codes) for management of domain 507 (DA) in a new registrar at flow 570. Domain 507 (DA) may be transferred to a registrar of choice of user 547 (User C). When the contact information was not set, the contact information (for user 547 (User C)) may be required as part of the transfer process for domain 507 (DA) and provided by user 547 (User C) (via client system 114) to DNS ownership manager 130.

In addition, escrow functionality may be used to prevent distribution of funds, onchain assets, and/or offchain assets until participants of a transfer transaction are satisfied. For example, a smart contract 146 may be configured with a contract specifying terms of the transfer transaction (e.g., assets, funds/payments, etc.) to serve as an escrow and control transfer of various items. When the contract terms are satisfied, the items are transferred. The smart contract may be associated with wallet accounts to receive and store the items of a transaction (e.g., cryptocurrency, onchain assets, etc.) for transfer to the appropriate participants.

A user may transfer the tokenized offchain asset between their own blockchain wallets (prior to transferring to another user). In this case, the user may indicate that they are the owner of both wallet accounts to allow uninterrupted Domain Name System (DNS) or other record updates through the signature of both wallets.

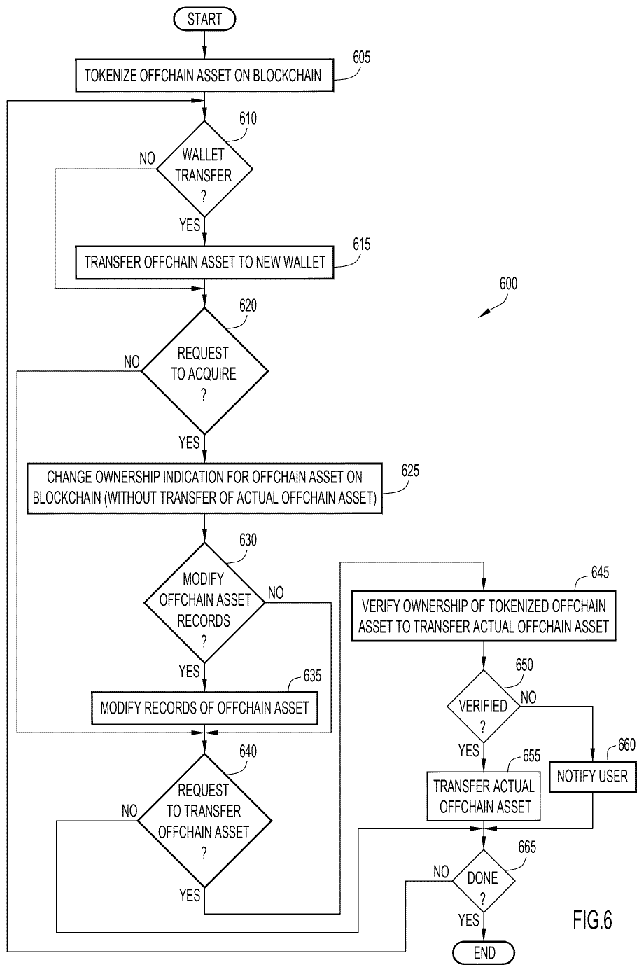

A method 600 of transferring an offchain asset between user wallet accounts for transfer to another user (e.g., via management module 116, registration module 132, smart contract 146, decentralized application (dApp) 148, blockchain related application 160, server system 110, client system 114, registration system 130, and/or blockchain system 140) according to an embodiment of the present invention is illustrated in FIG. 6. By way of example, method 600 is described with respect to an offchain asset including a Web2, ICANN, or Domain Name System (DNS) domain or domain name and an onchain asset representing the offchain asset by a non-fungible token (NFT). However, any onchain and offchain assets may be used in substantially the same manner described below.

An offchain asset (e.g., Web2 domain or domain name, ICANN domain or domain name, Domain Name System (DNS) domain or domain name, etc.) is tokenized on a blockchain (e.g., via management module 116, smart contract 146, decentralized application (dApp) 148, blockchain related application 160, etc.) at operation 605. Initially, a request to tokenize the offchain asset is issued for the wallet account of an initial user via a client system 114 to smart contract 146 (e.g., via management module 116, decentralized application (dApp) 148, blockchain related application 160, etc.). The initial user may be any entity owning or otherwise having rights to the offchain asset. The tokenization may be requested by any entity, such as an owner of the offchain asset, a registrar, a domain broker, a domain marketplace, etc.

A tokenized (or onchain) version of the offchain asset is created (e.g., via management module 116, smart contract 146, decentralized application (dApp) 148, blockchain related application 160, etc.) in the wallet account of the initial user. Once the tokenized version is created, a domain owner may be changed to a registrar (as opposed to an individual). For example, management module 116 may tokenize the offchain asset for the initial user on a blockchain in substantially the same manner described above (FIG. 3). The tokenization may include minting or publishing a non-fungible token (NFT) representing the offchain asset on the blockchain, and/or transferring the NFT from a previous owner to the initial user (e.g., places the onchain asset corresponding to the offchain asset in a user wallet account) via the smart contract. A user may include, or be associated with, any type of entity (e.g., individual, company, organization, etc.). Transfer of an onchain or offchain asset may include any action or transaction that provides ownership, rights, registration, custody, control, possession, and/or any other interest in the onchain or offchain asset. Further, acquiring or obtaining an onchain or offchain asset may include obtaining ownership, rights, registration, custody, control, possession, and/or any other interest in the onchain or offchain asset.

The initial user has plural wallet accounts and may desire to transfer the onchain asset (e.g., tokenized offchain asset, etc.) between the wallet accounts. When a wallet transfer is desired as determined at operation 610, the tokenized offchain asset is transferred to another wallet account of the initial user at operation 615. For example, the initial user of the wallet account containing the tokenized offchain asset (via client system 114) sends a request to smart contract 146 to transfer the tokenized offchain asset to another wallet account of the initial user (e.g., via management module 116, decentralized application (dApp) 148, blockchain related application 160, etc.). The transfer may be accomplished by providing a transaction to the blockchain in substantially the same manner described above. For example, management module 116 (e.g., via blockchain related application 160, smart contract 146, and/or distributed application (dApp) 148) transfers the onchain asset from the initial wallet account to another wallet account of the initial user (e.g., places the onchain asset corresponding to the offchain asset in the other wallet account). The transference of the onchain version to the new wallet account may be performed based on any required preferences. This may be accomplished by management module 116 (e.g., via blockchain related application 160, smart contract 146, and/or distributed application (dApp) 148) providing a transaction to the blockchain indicating acquisition of the onchain version (or NFT) by the other wallet account. In addition, various information for the onchain version (e.g., user information, asset information, wallet information, etc.) may be stored onchain and/or in offchain storage (e.g., database system 118, etc.).

Accordingly, the above process may be repeated from operation 610 to transfer the tokenized offchain asset between two or more wallet accounts in substantially the same manner described above until a request to acquire the offchain asset is received as determined at operation 620 or the process terminates as determined at operation 665 (e.g., power down, processing complete, etc.). In this case, Domain Name System (DNS) or other records for the offchain asset are not frozen since the initial user can sign for the sending and receiving wallet accounts to validate ownership of the tokenized offchain asset. In other words, prior to the transfer, the initial user can validate the receiving address of the onchain asset and skip proving ownership of the onchain asset. For example, when moving the onchain asset between two of their own wallets, the initial user can validate ownership of the second wallet prior to transfer and avoid having to prove ownership of the onchain asset again.

The initial user may request (via client system 114) that smart contract 146 list the offchain asset as available for a transaction (e.g., on a domain marketplace or other platform via management module 116) to enable another user to obtain the offchain asset. Alternatively, a direct request to another user may be issued to the smart contract.

When a request is received from a user of another wallet account to acquire the offchain asset as determined at operation 620, a transaction is conducted to change an ownership indication for the offchain asset on the blockchain from the wallet account of the initial user to the wallet account of the acquiring user (e.g., via management module 116, smart contract 146, decentralized application (dApp) 148, blockchain related application 160, etc.) at operation 625 (without transfer of the actual offchain asset to the acquiring user). An acquiring user may include, or be associated with, any type of entity (e.g., individual, company, organization, etc.). For example, the acquiring user may send a request to acquire the offchain asset (via a client system 114) to smart contract 146 (e.g., via management module 116, decentralized application (dApp) 148, blockchain related application 160, etc.). The acquiring user may be required to enter their contact information. For example, ICANN requires WHOIS data to correctly reflect the owner. The acquiring user may become the owner and, therefore, may need to provide their contact information pre-emptively.

Once the request is approved by the wallet account of the initial user (via client system 114), smart contract 146 transfers the tokenized (or onchain) version of the offchain asset to the wallet account of the acquiring user. The transfer may be accomplished by providing a transaction to the blockchain in substantially the same manner described above (FIG. 3). For example, management module 116 (e.g., via blockchain related application 160, smart contract 146, and/or distributed application (dApp) 148) transfers the tokenized offchain asset to the wallet account of the acquiring user (e.g., places the onchain asset corresponding to the offchain asset in the wallet account of the acquiring user). The acquisition of the onchain version may be performed based on any required preferences. This may be accomplished by management module 116 (e.g., via blockchain related application 160, smart contract 146, and/or distributed application (dApp) 148) providing a transaction to the blockchain indicating acquisition of the onchain version (or NFT) by the wallet account of the acquiring user. In addition, various information for the onchain version (e.g., user information, asset information, wallet information, etc.) may be stored onchain and/or in offchain storage (e.g., database system 118, etc.).

In some cases, Domain Name System (DNS) or other records for the offchain asset may be modified to suspend a domain and/or provide notifications (e.g., based on user or registrar preferences, etc.). When the DNS or other records are to be modified as determined at operation 630, the DNS or other records may be modified (e.g., via management module 116, registration system 130, etc.) to perform desired actions. By way of example, DNS or other records for the offchain asset may be cleared by registration system 130. For example, the records may include WHOIS records that would have otherwise indicated that the contact information for the offchain asset is that of the initial user. This may prevent abuse, where a user establishes a domain for improper content and transfers the onchain asset to a dead address to prevent updating. Accordingly, an administrator of the onchain registry can revoke onchain assets whenever necessary (e.g., via management module 116, smart contract 146, and/or blockchain related application 160). By way of example, conditions of abuse may be detected (e.g., improper content, notifications, etc.), and the corresponding onchain asset may be revoked (e.g., transferred to the prior owner or to an escrow or holding wallet, etc.).

Alternatively, the DNS or other records may be frozen by registration system 130 so that neither the initial user nor the acquiring user may change the records until the initial user or the acquiring user can validate ownership of the onchain version as described below. For example, when an onchain asset is transferred, a previous owner of the offchain asset may no longer be able to make updates to offchain asset records (e.g., the previous owner is no longer able to transfer an offchain domain to a new registrar, etc.). A new owner of the onchain asset can not make updates to the offchain asset until the onchain asset is properly verified. In other words, the records are frozen at the time of transfer of the onchain asset, and the previous owner can not make changes to the DNS records while they do not have the onchain asset. This is to prevent abuse, where someone could sell an offchain domain on the blockchain and transfer the offchain domain to a different registrar, thereby preventing a buyer from obtaining the purchased offchain domain. A new owner of the onchain asset proves ownership of the onchain asset as described below in order to gain management control access to the offchain asset. By way of further example, a landing page may be provided with an ownership or operational status for a domain, name servers may be changed, etc. to freeze the records. Since a transfer of the offchain asset is not requested or required at this point, unlocking or acquiring an authorization code is also not required.

In addition, during onchain transfer of ownership of the onchain version, the Domain Name System (DNS) or other records for the offchain asset may be modified by a registrar. For example, the registrar may update the contact information to reflect the new ownership as well as modify the name servers. This may be useful to provide a landing page showing a status that a domain is owned, but may not yet serve as a custom website.

The ownership indication for the offchain asset indicates the acquiring user on the blockchain, while the actual offchain asset remains untransferred (and typically with the initial user) until the acquiring user requests transfer of the actual offchain asset (or other event occurs) requiring update of the DNS or other records. Accordingly, the above process may be repeated from operation 620 to transfer ownership of the onchain asset from the wallet account of the acquiring user to wallet accounts of one or more additional users (e.g., an effective or constructive transfer of the offchain asset while the actual offchain asset remains with the initial user) in substantially the same manner described above until a request to transfer the actual offchain asset is received as determined at operation 640 or the process terminates as determined at operation 665 (e.g., power down, processing complete, etc.).

For example, a user of a wallet account currently having ownership in the offchain asset may request that the offchain asset be listed (e.g., on a domain marketplace or other platform via management module 116) as available in substantially the same manner described above. The above process may repeatedly transfer ownership of the onchain asset to wallet accounts of one or more additional users (e.g., an effective or constructive transfer of the offchain asset while the actual offchain asset remains with the initial user). This enables immediate constructive transfer of the ownership of the offchain asset without requiring the time consuming processes of unlocking and use of authorization codes.

A current user of a wallet account acquiring the ownership of the onchain asset may desire to transfer the actual offchain asset from the initial user to the current acquiring user. For example, the current acquiring user may desire to modify the DNS or other records of the offchain asset to perform the transfer. When a request to transfer the offchain asset is received as determined at operation 640, the ownership of the tokenized (or onchain) version is verified at operation 645. For example, the current acquiring user may send a request to registration system 130 (via client system 114 and management module 116) and a domain validation management layer of the registration system processes a validation request in order to modify the DNS or other records. For example, the validation may include verifying the tokenized version of the offchain asset is owned or in custody of the current acquiring user.

The validation may be accomplished by registration system 130 sending a request to smart contract 146 to check the wallet account of the current acquiring user in combination with a blockchain signature. For example, the smart contract may access the wallet account of the current acquiring user based on credentials provided by the current acquiring user, where the wallet account includes the onchain assets of the current acquiring user. Smart contract 146 examines the onchain assets of the wallet account and determines a presence of the tokenized version of the offchain asset within the wallet account. By way of example, the onchain assets of the wallet account may be determined by searching transactions on a corresponding blockchain indicating acquisition of onchain assets by the wallet account. The presence of the tokenized version of the offchain asset may be determined based on the names and/or extensions of the onchain assets and/or records of the onchain assets indicating corresponding offchain versions.

In addition, the current acquiring user of the wallet account may sign a message (e.g., via a client system 114 and initiated via smart contract 146 through management module 116, decentralized application (dApp) 148, blockchain related application 160, etc.) with the wallet account containing the onchain asset (or tokenized offchain asset) to confirm acquisition of the onchain asset by the current acquiring user. By way of example, signing of the message in a crypto wallet account (e.g., custodied, self-custody, etc.) generates a digital signature of the message based on the private key of the wallet account. The signed message or digital signature is decrypted for verification (e.g., by an add-on or plug-in of interface module 122 of client system 114) based on a public key (e.g., blockchain address, etc.) corresponding to the wallet account. Since the private key is unique to the wallet account, successful decryption of the message with the corresponding public key verifies the message was sent by the current acquiring user. The current acquiring user may sign a message with the wallet account containing the onchain asset (or tokenized offchain asset) to confirm acquisition of the onchain asset by the current acquiring user. A response may be provided (e.g., from the add-on or plug-in of interface module 122) indicating a result of the decryption of the signed message which may be sent to smart contract 146 (e.g., via management module 116, decentralized application (dApp) 148, blockchain related application 160, etc.).

Smart contract 146 sends a notification to registration system 130 (e.g., via management module 116, decentralized application (dApp) 148, blockchain related application 160, etc.) indicating ownership verification. In addition, the current acquiring user may be verified to comply with offchain asset regulations prior to the offchain asset being transferred to the acquiring user (e.g., entering and verifying an email address, etc.).

When validation fails (e.g., the wallet account of the current acquiring user does not possess the tokenized version of the offchain asset, the blockchain signature is invalid, and/or offchain asset regulations are violated) as determined at operation 650, the request to modify the DNS or other records is rejected, and an error message may be shown to the current acquiring user (via client system 114) at operation 660. The above process repeats from operation 610 until the process terminates (e.g., power down, processing complete, etc.) as determined at operation 665.

When the validation is successful (e.g., the wallet account of the current acquiring user does possess the tokenized version of the offchain asset, the blockchain signature is valid, any offchain asset regulations are satisfied, etc.), DNS or other records may be edited at the current registrar to transfer the actual offchain asset to the current acquiring user (using the same registrar) at operation 655.

Alternatively, a request for the offchain asset to be transferred to a new registrar may be sent from registration system 130 to client system 114 of the initial user. The initial user performs the transfer process (e.g., with respect to unlocking and authorization codes) for management of the offchain asset in a new registrar. The offchain asset may be transferred to a registrar of choice of the current acquiring user. When the contact information was not set, the contact information (for the current acquiring user) may be required as part of the transfer process for the offchain asset, and provided by the current acquiring user (via client system 114) to registration system 130.

In addition, escrow functionality may be used to prevent distribution of funds, onchain assets, and/or offchain assets until participants of a transfer transaction are satisfied. For example, a smart contract 146 may be configured with a contract specifying terms of the transfer transaction (e.g., assets, funds/payments, etc.) to serve as an escrow and control transfer of various items. When the contract terms are satisfied, the items are transferred. The smart contract may be associated with wallet accounts to receive and store the items of a transaction (e.g., cryptocurrency, onchain assets, etc.) for transfer to the appropriate participants.

Accordingly, the tokenized offchain asset may be transferred to or between any quantity of wallet accounts of a user. Further, the ownership of the offchain asset may be effectively or constructively transferred to or between any quantity of users (as indicated on the blockchain), while transfer of the actual offchain asset is deferred or delayed until a current acquiring user requests transfer of the actual offchain asset (or other event occurs) requiring update of DNS or other records for the offchain asset. During the deferral or delay, the offchain asset remains with one of the prior owners (the initial user or an additional user that requested transfer of the actual offchain asset). Thus, the above process may be repeated from operation 610 to transfer the tokenized offchain asset between wallet accounts, constructively transfer ownership of the offchain asset, and defer transfer of the actual offchain asset until requested in substantially the same manner described above until the process terminates (e.g., power down, processing complete, etc.) as determined at operation 665. This enables immediate constructive transfer of the ownership of the offchain asset to users without requiring the time consuming processes of unlocking and use of authorization codes.

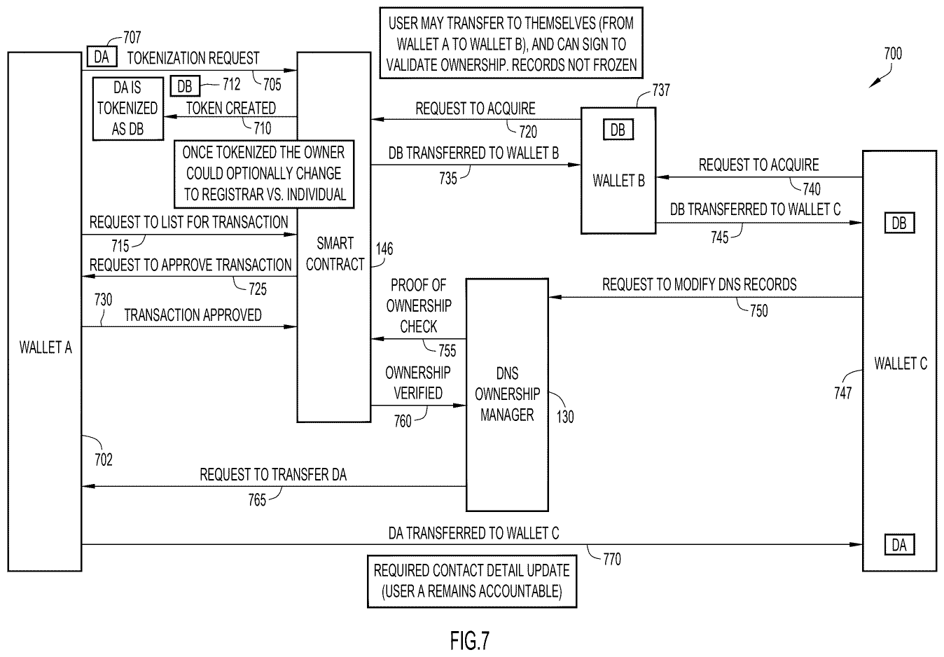

A method 700 of transferring an offchain asset between user wallet accounts for transfer to another user (e.g., via management module 116, registration module 132, smart contract 146, decentralized application (dApp) 148, blockchain related application 160, server system 110, client system 114, registration system 130, and/or blockchain system 140) according to an embodiment of the present invention is illustrated in FIG. 7. By way of example, method 700 is described with respect to an offchain asset including a Web2, ICANN, or Domain Name System (DNS) domain or domain name and an onchain asset representing the offchain asset by a non-fungible token (NFT). However, any onchain and offchain assets may be used in substantially the same manner described below.

Initially, a user has wallet accounts 702, 737 (e.g., Wallet A and Wallet B as viewed in FIG. 7) and desires to transfer an onchain asset (e.g., tokenized domain, etc.) between the wallets. A request to tokenize a DNS domain 707 (e.g., DA as viewed in FIG. 7) is issued for wallet account 702 (Wallet A) via a client system 114 to smart contract 146 (e.g., via management module 116, decentralized application (dApp) 148, blockchain related application 160, etc.) at flow 705. The tokenization may be requested by an owner of the domain, a registrar, a domain broker, a domain marketplace, etc.

A tokenized (or onchain) version of domain 707 (DA) is created as domain 712 (e.g., DB as viewed in FIG. 7) at flow 710 (e.g., via management module 116, smart contract 146, decentralized application (dApp) 148, blockchain related application 160, etc.). Once the tokenized version is created, the owner may change to a registrar (as opposed to an individual). For example, management module 116 may tokenize an offchain asset (e.g., Web2 domain or domain name, ICANN domain or domain name, Domain Name System (DNS) domain or domain name, etc.) on a blockchain for wallet account 702 (Wallet A) in substantially the same manner described above (FIG. 3). The tokenization may include minting or publishing a non-fungible token (NFT) representing the offchain asset on the blockchain, and/or transferring the NFT from a current owner to the user (e.g., places the onchain asset in a user wallet account) via the smart contract. A user may include, or be associated with, any type of entity (e.g., individual, company, organization, etc.). Transfer of an onchain or offchain asset may include any action or transaction that provides ownership, rights, registration, custody, control, possession, and/or any other interest in the onchain or offchain asset. Further, acquiring or obtaining an onchain or offchain asset may include obtaining ownership, rights, registration, custody, control, possession, and/or any other interest in the onchain or offchain asset.

The user of wallet account 702 (Wallet A) requests (via client system 114) that smart contract 146 list domain 707 (DA) as available for a transaction for wallet transfer at flow 715 in substantially the same manner described above. Alternatively, a direct request to a wallet to transfer domain 707 (DA) may be issued to the smart contract.

The user desires to transfer domain 707 (DA) from wallet account 702 (Wallet A) to wallet account 737 (Wallet B) and sends a request to transfer domain 707 (DA) (via client system 114) to smart contract 146 (e.g., via management module 116, decentralized application (dApp) 148, blockchain related application 160, etc.) at flow 720.

Smart contract 146 sends a request to client system 114 for wallet account 702 (Wallet A) (e.g., via management module 116, decentralized application (dApp) 148, blockchain related application 160, etc.) for the user to approve the wallet transfer request at flow 725. Client system 114 for wallet account 702 (Wallet A) sends approval of the request to smart contract 146 (e.g., via management module 116, decentralized application (dApp) 148, blockchain related application 160, etc.) at flow 730. Smart contract 146 transfers domain 712 (DB) (or the tokenized version of domain 707 (DA)) to wallet account 737 (Wallet B) at flow 735.

The transfer may be accomplished by providing a transaction to the blockchain in substantially the same manner described above. For example, smart contract 146 transfers the onchain asset (e.g., domain 712 (DB)) from wallet account 702 (Wallet A) to wallet account 737 (Wallet B) (e.g., places the onchain asset corresponding to the offchain asset in wallet account 737 (Wallet B)). The transference of the onchain version to the new wallet account may be performed based on any required preferences. This may be accomplished by smart contract 146 providing a transaction to the blockchain indicating acquisition of the onchain version (or NFT) by the new wallet account. In addition, various information for the onchain version (e.g., user information, asset information, wallet information, etc.) may be stored onchain and/or in offchain storage (e.g., database system 118, etc.).

In this case, Domain Name System (DNS) or other records are not frozen since the user can sign for both wallet accounts 702, 737 (Wallet A and Wallet B) to validate ownership of domain 712 (DB).

The user of wallet account 737 (Wallet B) may request that domain 712 (DA) be listed as available in substantially the same manner described above. A user of another wallet account 747 (e.g., Wallet C as viewed in FIG. 7) desires to acquire domain 707 (DA) from wallet account 737 (Wallet B), and sends a request (via a client system 114) to client system 114 for wallet account 737 (Wallet B) (e.g., via management module 116, etc.) at flow 740. Wallet account 737 (Wallet B) (now containing domain 712 (DB)) approves the request and enables transfer of domain 712 (DB) (tokenized version of domain 707 (DA)) to wallet account 747 (Wallet C) at flow 745. The transfer may be accomplished by providing a transaction to the blockchain in substantially the same manner described above.

Domain Name System (DNS) or other records for domain 707 (DA) may be cleared by DNS ownership manager 130 (e.g., corresponding to registration system 130). For example, the records may include WHOIS records that would have otherwise indicated that the contact information for domain 707 (DA) is the initial user (of wallet accounts 702, 737 (Wallets A and B)). Alternatively, DNS or other records may be frozen at this point by DNS ownership manager 130 so that neither users (user of wallet accounts 702, 737 (Wallets A and B) and user of wallet account 747 (Wallet C)) may change the records until they can validate ownership of onchain domain 712 (DB) as described below. For example, a landing page may be provided, name servers may be changed, etc. to freeze the records. Since a transfer of domain 707 (DA) (on Web2) is not requested or required at this point, unlocking or acquiring an authorization code is also not required.

In addition, during onchain transfer of ownership of the onchain version, the offchain DNS or other records may be modified by a registrar. For example, the registrar may update the contact information to reflect the paid ownership as well as modify the name servers. This may be useful to provide a landing page showing that a domain is owned, but may not yet serve as a custom website.

The user of wallet account 747 (Wallet C) desires to modify the DNS or other records of domain 707 (DA) to transfer domain 707 (DA), and sends a request to DNS ownership manager 130 via client system 114 at flow 750. A domain validation management layer of the DNS ownership manager processes a validation request in order to modify the DNS or other records. For example, the validation may include verifying domain 712 (DB) (the tokenized version of domain 707 (DA)) is in custody of the user of wallet account 747 (Wallet C) requesting validation.

The validation may be accomplished by DNS ownership manager 130 sending a request to smart contract 146 to check wallet account 747 (Wallet C) in combination with a blockchain signature at flow 755. For example, the smart contract may access wallet account 747 (Wallet C) based on credentials provided by the user of wallet account 747 (Wallet C), where wallet account 747 (Wallet C) includes the onchain assets acquired by the user in substantially the same manner described above. In addition, the user of wallet account 747 (Wallet C) may sign a message (e.g., via a client system 114 and initiated via smart contract 146 through management module 116, decentralized application (dApp) 148, blockchain related application 160, etc.) in wallet account 747 (Wallet C) containing the onchain asset (or tokenized offchain asset) to confirm acquisition of the onchain asset by the user in substantially the same manner described above.

Smart contract 146 sends a notification to DNS ownership manager 130 (e.g., via management module 116, decentralized application (dApp) 148, blockchain related application 160, etc.) indicating ownership verification at flow 760. When validation fails (e.g., wallet account 747 (Wallet C) does not possess domain 712 (DB) or the blockchain signature is invalid), the request to modify the DNS or other records is rejected, and an error message may be shown to the user of wallet account 747 (Wallet C) (via client system 114). When the validation is successful (e.g., wallet account 747 (Wallet C) does possess domain 712 (DB) and the blockchain signature is valid), DNS or other records may be edited for transfer of domain 707 (DA) at the current registrar, or a request for domain 707 (DA) to be transferred to a new registrar is sent from DNS ownership manager 130 to the client system for wallet account 702 (Wallet A) at flow 765.

The user of wallet account 702 (Wallet A) performs the transfer process (e.g., with respect to unlocking and authorization codes) for management in a new registrar at flow 770. Domain 707 (DA) may be transferred to the registrar of choice of the user of wallet account 747 (Wallet C). Further, the contact information for the user of wallet account 747 (Wallet C) is required as part of the transfer process for domain 707 (DA), and the information is provided by the user of wallet account 747 (Wallet C) (via client system 114) to registration system 130.

In addition, escrow functionality may be used to prevent distribution of funds, onchain assets, and/or offchain assets until participants of a transfer transaction are satisfied. For example, a smart contract 146 may be configured with a contract specifying terms of the transfer transaction (e.g., assets, funds/payments, etc.) to serve as an escrow and control transfer of various items. When the contract terms are satisfied, the items are transferred. The smart contract may be associated with wallet accounts to receive and store the items of a transaction (e.g., cryptocurrency, onchain assets, etc.) for transfer to the appropriate participants.

Present invention embodiments may provide various technical and other advantages. For example, present invention embodiments provide enhanced manners of accessing an asset, and enable use of asset identifiers (and access of corresponding assets) across different networks (e.g., DNS and blockchain, etc.). Present invention embodiments enable transactions using any of the corresponding offchain and onchain identifiers or domain names, thereby providing new functionality to an identifier of a network that is absent on that network (e.g., send cryptocurrency to a centralized or Web2 domain name, etc.).

Further, present invention embodiments provide enhanced security for offchain assets by leveraging blockchain technology to identify appropriate owners (e.g., blockchain signatures, etc.) and prevent wrongful acquisition of the assets. Moreover, present invention embodiments enable transfer of offchain assets whose transfer is otherwise restricted. This controls transference of assets on centralized systems based on transference of onchain assets of a decentralized system.

It will be appreciated that the embodiments described above and illustrated in the drawings represent only a few of the many ways of implementing embodiments for blockchain based transfer of offchain assets. In addition, characteristics or features of embodiments of the present invention may be combined in any fashion to provide additional embodiments of the present invention.

The environment of the present invention embodiments may include any number of computer or other processing systems (e.g., client or end-user systems, server systems, registration systems, blockchain systems, etc.) and databases or other repositories arranged in any desired fashion, where the present invention embodiments may be applied to any desired type of computing environment (e.g., cloud computing, client-server, network computing, mainframe, stand-alone systems, etc.). The computer or other processing systems employed by the present invention embodiments may be implemented by any number of any personal or other type of computer or processing system (e.g., desktop, laptop, hand-held devices, smartphones or other mobile devices, etc.), and may include any commercially available operating system and any combination of commercially available and custom software (e.g., communications software; server software; software of present invention embodiments (including management module 116, interface module 122, registration module 132, smart contracts 146, decentralized applications (dApps) 148, blockchain related applications 160, etc.); etc.). These systems may include any types of monitors and input devices (e.g., keyboard, mouse, voice recognition, etc.) to enter and/or view information.

It is to be understood that the software of the present invention embodiments (e.g., management module 116, interface module 122, registration module 132, smart contracts 146, decentralized applications (dApps) 148, blockchain related applications 160, etc.) may be implemented in any desired computer language and could be developed by one of ordinary skill in the computer arts based on the functional descriptions contained in the specification and flowcharts illustrated in the drawings. Further, any references herein of software performing various functions generally refer to computer systems or processors performing those functions under software control. The computer systems of the present invention embodiments may alternatively be implemented by any type of hardware and/or other processing circuitry.

The various functions of the computer or other processing systems may be distributed in any manner among any number of software and/or hardware modules or units, processing or computer systems and/or circuitry, where the computer or processing systems may be disposed locally or remotely of each other and communicate via any suitable communications medium (e.g., LAN, WAN, Intranet, Internet, hardwire, modem connection, wireless, etc.). For example, the functions of the present invention embodiments may be distributed in any manner among the various end-user/client, server, registration, and blockchain systems, and/or any other intermediary processing devices. The software and/or algorithms described above and illustrated in the flowcharts may be modified in any manner that accomplishes the functions described herein. In addition, the functions in the flowcharts or description may be performed in any order that accomplishes a desired operation.

The software of the present invention embodiments (e.g., management module 116, interface module 122, registration module 132, smart contracts 146, decentralized applications (dApps) 148, blockchain related applications 160, etc.) may be available on a non-transitory computer useable or readable medium (e.g., magnetic or optical mediums, magneto-optic mediums, CD-ROM, DVD, memory devices, etc.) of a stationary or portable computer program product, apparatus, or device for use with stand-alone systems or systems connected by a network or other communications medium. The computer usable or readable medium (or media) may include instructions executable by one or more processors to perform functions of present invention embodiments described herein.

The communication network may be implemented by any number of any type of communications network (e.g., LAN, WAN, Internet, Intranet, VPN, etc.). The computer or other processing systems of the present invention embodiments may include any conventional or other communications devices to communicate over the network via any conventional or other protocols. The computer or other processing systems may utilize any type of connection (e.g., wired, wireless, etc.) for access to the network. Local communication media may be implemented by any suitable communication media (e.g., local area network (LAN), hardwire, wireless link, Intranet, etc.).

The system may employ any number of any conventional or other databases, data stores or storage structures (e.g., files, databases, data structures, data or other repositories, etc.) to store information (e.g., blockchain asset information, metadata, mappings of blockchain assets to blockchains, preferences, etc.). The database system may be implemented by any conventional or other databases, data stores or storage structures to store information. The database system may be included within or coupled to the server, client, registration, and/or blockchain systems. The database systems and/or storage structures may be remote from or local to the computer or other processing systems, and may store any desired data.

The present invention embodiments may employ any number of any type of user interface (e.g., Graphical User Interface (GUI), command-line, prompt, etc.) for obtaining or providing information (e.g., preferences, results of registration, notifications, domain or web site content, blockchain asset information, etc.), where the interface may include any information arranged in any fashion. The interface may include any number of any types of input or actuation mechanisms (e.g., buttons, icons, fields, boxes, links, etc.) disposed at any locations to enter/display information and initiate desired actions via any suitable input devices (e.g., mouse, keyboard, etc.). The interface screens may include any suitable actuators (e.g., links, tabs, etc.) to navigate between the screens in any fashion.

The report may include any information arranged in any fashion, and may be configurable based on rules or other criteria to provide desired information to a user (e.g., blockchain assets, status and/or information of onchain and/or offchain assets, registrations, preferences, etc.).

The present invention embodiments are not limited to the specific tasks or algorithms described above, but may be utilized for transferring any offchain assets based on transference of any corresponding onchain assets. For example, a corresponding onchain asset may be transferred among users to indicate a change in ownership of an offchain asset while the offchain asset remains as-is without transfer to a new owner (e.g., DNS or other records still indicate a prior owner) until transference of the actual offchain asset is required or requested.

An asset may include any item or object associated with a computer or network environment (e.g., a domain, a domain name, a set of records, an object that points to a set of records, a non-fungible token (NFT), non-fungible token (NFT) domain names, a fungible token, a wallet address, email or other service, communication entity, etc.). An onchain asset may include any asset residing on, or supported by, a blockchain or other decentralized system (e.g., Web3 asset, asset of a decentralized system, asset of a partial or hybrid decentralized system, etc.). An offchain asset may include any asset residing on, or supported by, a centralized system or a system with centralized control (e.g., Web2, Domain Name System (DNS), ICANN accredited domain names, system other than a decentralized system described above, etc.). An onchain system may include any blockchain or other decentralized system (e.g., Web3, decentralized system, partial or hybrid decentralized system, etc.), while an offchain system may include any centralized system or system with centralized control (e.g., Web2, Domain Name System (DNS), system other than a decentralized system described above, etc.).

The name or other identifier for the offchain and onchain assets may include a name portion and an optional extension (e.g., “name.e1”, etc.). Alternatively, the name or other identifier may include the name portion without the extension. The name portion and extension may each include any quantity of terms, words, tokens, or arrangements of any quantity of any types of elements (e.g., alphanumeric or other characters, symbols, numbers, etc.).

Any quantity of any parameters, values, or other information may be associated with an asset. The information for an offchain asset may include any information arranged in any fashion (e.g., values for domain records, domain parameters, server names or addresses, etc.). Any information of an offchain asset may be stored for an onchain asset to link the assets. This information may be stored on a blockchain and/or on an offchain data source in any storage item (e.g., record, data object, etc.). The information for an onchain asset may include any information arranged in any fashion (e.g., values for asset attributes, blockchain, wallet address, user/owner information etc.). Any information of an onchain asset may be stored for an offchain asset to link the assets. This information may be stored on a blockchain and/or on an offchain data source in any storage item (e.g., record, data object, etc.). The offchain data source may include any storage structure (e.g., decentralized storage structure or platform, blockchain storage, database, etc.). The asset information may be stored and retrieved based on any information (e.g., based on registered user information (e.g., wallet address, blockchain asset, blockchain domain or user name, user information, etc.)).

The onchain assets may be from any desired blockchains. Availability for an onchain asset may be determined by searching any onchain and/or offchain storage for any corresponding records or information indicating existence of the onchain asset on a system. Further, availability for an offchain asset may be determined by searching any onchain and/or offchain storage for any corresponding records or information indicating existence of the offchain asset on a system.

A name of an asset of a system may be used to access any corresponding assets of any other systems. For example, the information for the asset may indicate the information (e.g., names or identifiers, addresses, etc.) of the corresponding assets. The information may be retrieved based on the name of the asset and used to resolve the name of the asset to the location (e.g., system, name, address, etc.) of the corresponding assets on the other systems to access (and/or perform transactions) with respect to those corresponding assets. By way of example, a user may send cryptocurrency (e.g., a loan or other payment) to a Web2 domain name.

A user may include, or be associated with, any type of entity (e.g., individual, company, organization, decentralized autonomous organization (DAO), etc.). Transfer of an onchain or offchain asset may include any action or transaction that provides ownership, rights, registration, custody, control, possession, and/or any other interest in the onchain or offchain asset. Further, an interest may include ownership, rights, registration, custody, possession, control, and/or any other stake or share in the onchain or offchain asset. Moreover, acquiring or obtaining an onchain or offchain asset may include obtaining ownership, rights, registration, custody, control, possession, and/or any other interest in the onchain or offchain asset.

The onchain asset (and offchain asset) may be obtained via any type of transaction. Any suitable proof of acquisition or ownership may be used to prove acquisition or ownership of an asset in order to transfer a corresponding asset (e.g., examine user wallet, examine Domain Name System (DNS) or other records for offchain assets, wallet or other signatures or authorizations, etc.). A corresponding onchain asset may be transferred any quantity of times among users to constructively change ownership of an offchain asset while the offchain asset remains as-is without transfer to a new owner (e.g., modification of DNS records still indicate a prior owner). The actual transfer of the offchain asset may be deferred or delayed for any quantity of time or quantity of onchain transferences until the actual transference (e.g., updating of DNS or other records, etc.) is required or requested.

The transfer of the onchain asset may be accomplished via any blockchain or other transaction. For example, a transfer may be accomplished by conducting a transaction on the blockchain to indicate transfer of the onchain asset to a new owner. Further, transfer of the offchain asset may be accomplished by modifying any corresponding records of the offchain asset (e.g., Domain Name System (DNS) records, etc.). Moreover, access to the records of the offchain asset may be accomplished by modifying any corresponding records of the offchain asset (e.g., Domain Name System (DNS) records, etc.), and may be performed in response to transfer of the offchain asset.

The assets and corresponding assets may be the same or different types of assets, and may be on the same or different types of systems (e.g., centralized, decentralized, etc.).

Having described preferred embodiments of a new and improved system, method, and computer program product for blockchain based transfer of offchain assets, it is believed that other modifications, variations and changes will be suggested to those skilled in the art in view of the teachings set forth herein. It is therefore to be understood that all such variations, modifications and changes are believed to fall within the scope of present invention embodiments as defined by the appended claims.

What is claimed is:

1. A method of transferring assets of a computer environment comprising:
acquiring, via at least one processor, an onchain asset of a blockchain for a user, wherein the onchain asset corresponds to an offchain asset of the user and indicates ownership of the offchain asset;
transferring, via the at least one processor, the onchain asset to one or more recipients on the blockchain, wherein transferring the onchain asset changes an ownership indication on the blockchain for the offchain asset to a corresponding recipient;
deferring, via the at least one processor, transfer of the offchain asset until requested by a recipient possessing the onchain asset; and
transferring, via the at least one processor, the offchain asset to the recipient in response to a request from the recipient to transfer the offchain asset.

2. The method of claim 1, wherein the offchain asset includes a centralized domain name and the onchain asset includes a non-fungible token.

3. The method of claim 1, further comprising:
preventing, via the at least one processor, one or more changes to records for the offchain asset during deferral of the transfer of the offchain asset.

4. The method of clam 1, wherein transferring the offchain asset to the recipient comprises:
verifying the onchain asset resides in a wallet account of the recipient and a signed message from the wallet account.

5. The method of claim 1, wherein the onchain asset is transferred from the user to a plurality of recipients prior to transferring the offchain asset.

6. The method of claim 2, further comprising:
modifying, via the at least one processor, records of the offchain asset during deferral of the transfer of the offchain asset to provide a page with a notification for a status of the centralized domain name.

7. The method of claim 1, further comprising:
updating, via the at least one processor, records of the offchain asset with recipient information in response to transferring the offchain asset to the recipient.

8. A system for transferring assets of a computer environment comprising:
one or more memories; and
at least one processor coupled to the one or more memories, the at least one processor configured to:
acquire an onchain asset of a blockchain for a user, wherein the onchain asset corresponds to an offchain asset of the user and indicates ownership of the offchain asset;
transfer the onchain asset to one or more recipients on the blockchain, wherein transferring the onchain asset changes an ownership indication on the blockchain for the offchain asset to a corresponding recipient;
defer transfer of the offchain asset until requested by a recipient possessing the onchain asset; and
transfer the offchain asset to the recipient in response to a request from the recipient to transfer the offchain asset.

9. The system of claim 8, wherein the offchain asset includes a centralized domain name and the onchain asset includes a non-fungible token.

10. The system of claim 8, wherein the at least one processor is further configured to:
prevent one or more changes to records for the offchain asset during deferral of the transfer of the offchain asset.

11. The system of clam 8, wherein transferring the offchain asset to the recipient comprises:
verifying the onchain asset resides in a wallet account of the recipient and a signed message from the wallet account.

12. The system of claim 8, wherein the onchain asset is transferred from the user to a plurality of recipients prior to transferring the offchain asset.

13. The system of claim 9, wherein the at least one processor is further configured to:
modify records of the offchain asset during deferral of the transfer of the offchain asset to provide a page with a notification for a status of the centralized domain name.

14. The system of claim 8, wherein the at least one processor is further configured to:
update records of the offchain asset with recipient information in response to transferring the offchain asset to the recipient.

15. A computer program product for transferring assets of a computer environment, the computer program product comprising one or more non-transitory computer readable media having instructions stored thereon, the instructions executable by at least one processor to cause the at least one processor to:
acquire an onchain asset of a blockchain for a user, wherein the onchain asset corresponds to an offchain asset of the user and indicates ownership of the offchain asset;
transfer the onchain asset to one or more recipients on the blockchain, wherein transferring the onchain asset changes an ownership indication on the blockchain for the offchain asset to a corresponding recipient;
defer transfer of the offchain asset until requested by a recipient possessing the onchain asset; and
transfer the offchain asset to the recipient in response to a request from the recipient to transfer the offchain asset.

16. The computer program product of claim 15, wherein the offchain asset includes a centralized domain name and the onchain asset includes a non-fungible token.

17. The computer program product of claim 15, wherein the instructions further cause the at least one processor to:
prevent one or more changes to records for the offchain asset during deferral of the transfer of the offchain asset.

18. The computer program product of claim 15, wherein transferring the offchain asset to the recipient comprises:
verifying the onchain asset resides in a wallet account of the recipient and a signed message from the wallet account.

19. The computer program product of claim 15, wherein the onchain asset is transferred from the user to a plurality of recipients prior to transferring the offchain asset.

20. The computer program product of claim 16, wherein the instructions further cause the at least one processor to:
modify records of the offchain asset during deferral of the transfer of the offchain asset to provide a page with a notification for a status of the centralized domain name.

21. The computer program product of claim 15, wherein the instructions further cause the at least one processor to:
update records of the offchain asset with recipient information in response to transferring the offchain asset to the recipient.
